(19) United States
(12) Patent Application Publication
(10) Pub. No.: US 2025/0187383 A1
(43) Pub. Date: Jun. 12, 2025

(54) IMPROVEMENTS RELATING TO TENSILE RESTRAINTS

(71) Applicant: Bartlett Transport Improvements Pty. Ltd., Hallam (AU)

(72) Inventors: Allan James Bartlett, Hallam (AU); Wayne Andrew Baker, Hallam (AU)

(73) Assignee: Bartlett Transport Improvements Pty. Ltd., Hallam (AU)

(21) Appl. No.: 18/976,104

(22) Filed: Dec. 10, 2024

(30) Foreign Application Priority Data
Dec. 11, 2023 (AU) 2023903998

(51) Int. Cl. B60D 1/18

(52) U.S. Cl. CPC B60D 1/187

(57) ABSTRACT

A coupling device for interconnecting a tensile restraint member and a structural component, the coupling device including: a body adapted to be supported from the structural component; and a linkage having: a proximal end adapted to be rotatably coupled to the body such that the linkage or proximal end is rotationally displaceable relative to the body about a transverse axis; and a distal end configured such that said tensile restraint member is connectable thereto.

### CROSS-REFERENCE TO RELATED APPLICATION

This application claims priority to Australian Application No. 2023903998, which was filed on Dec. 11, 2023, and entitled IMPROVEMENTS RELATING TO TENSILE RESTRAINTS; the entire disclosure of which is incorporated herein.

### FIELD OF THE INVENTION

The present invention relates to tensile restraints, especially restraints which comprise elongate tensile members, including flexible members, such as chains, cables, straps, wires, ropes and tendons, and relatively rigid members, such as rods.

The invention has particular application to vehicle towing safety restraints, especially those comprising safety chains and cables.

Although herein described principally in relation to vehicle towing applications, the invention also has application to (inter alia) load binding (including restraints for securing loads supported on vehicle trays and beds), guying/restraining of structures, loading lifting/handling of loads, and harnessing.

### BACKGROUND

In order for a locomotively powered or hauled vehicle to tow another vehicle (which is typically unpowered) such as a trailer, it is necessary to provide a mechanical connection between the former vehicle (“towing vehicle”) and the latter vehicle (“towed vehicle”). Because coupling assemblies used to do so can fail in service, it is generally desirable, and typically mandatory, to provide a (secondary) means of interconnecting the vehicles whereby the towed vehicle remains connected to the towing vehicle (so that the vehicles are retained one-to-the-other) in the event of such a failure. Typically, regulations (such as Australian Design Rule 62) prescribe, to that end, an arrangement, comprising chains or cables or the like, via which the towed vehicle is tethered to the towing vehicle. Reliability of the secondary connection is of critical importance, particularly for protection of people, including the vehicle driver/occupants, motorists and pedestrians, and of infrastructure, property and freight.

Referring to FIG. 1, one arrangement-which is particularly common in a number of parts of the world, especially the Americas, including the United States, Canada, Mexico/Latin America, and parts of Asia, such as (for example) China and India—for interconnecting a towing vehicle V (which, for instance, may be a truck or lorry, or otherwise be a heavy haulage vehicle) and a towed vehicle T (such as a trailer) comprises a hanger 6, typically comprising a U-shaped bar 5 secured at its ends to the vehicle V, at least one chain 2 secured at a rear end thereof to the towed vehicle T—typically a pair of such chains 2—and, secured to the front end of the/each chain 2, a (respective) sling hook 3, comprising a hook member 9 and a resiliently biased latch 7 defining a connector securable to the hanger 6. The latch 7 is pivotally connected to the hook member 9 so that it can, when urged against the bar 5, be rotationally displaced, against the resilient bias, from a closed position to an open position to permit receipt of the hook member 9 over/around the bar 5. Once the latch 7 ceases to be urged against the bar 5, it is returned, under the action of the bias, to the closed position, in which it precludes decoupling of the sling hook 3 and the hanger 6 or bar 5. It is not unusual, where this arrangement is employed, for the coupling assembly, providing the (primary, in-service) mechanical connection between vehicles V and T, to comprise a pintle hook coupling 4.

It is typical for the bar 5 to be relatively long, thus defining a relatively large perimeter throughout which the sling hook 3 is engageable with the bar 5 to be connected to the hanger 6 whereby interconnection of the sling hook 3 and hanger 6 is facilitated.

If the trailer hitch fails, the chain 2 and the arrangement via which it is connected to the vehicle V, the latter comprising the hook 3 and hanger 6, can be subjected to significant loads and may fail, potentially resulting in complete separation of the trailer and the vehicle.

It is generally desirable to overcome or ameliorate one or more of the difficulties of the prior art, or to at least provide a useful alternative.

### SUMMARY OF THE INVENTION

One or more embodiments of the present invention provide a coupling device for interconnecting a tensile restraint member and a structural component, the coupling device comprising:
a body adapted to be supported from the structural component; and
a linkage having:
   a proximal end adapted to be rotatably coupled to the body such that the linkage or proximal end is rotationally displaceable relative to the body about a transverse axis; and
   a distal end configured such that said tensile restraint member is connectable thereto.

Preferably, the linkage and the body have respective complementary portions such that a close fit is maintained therebetween throughout a range of rotational displacement of the linkage about the axis.

Preferably, said coupling device includes a connecting member via which said proximal end is engageable or engaged with the body to be rotatably coupled thereto. Preferably, the transverse axis is defined by a central axis of said connecting member.

In a preferred embodiment, the linkage and the body have respective complementary portions such that a close fit is maintained therebetween throughout a range of rotational displacement of the linkage about the axis.

In a preferred embodiment of the invention, the body defines a clevis having laterally spaced arms arranged to receive said proximal end therebetween, and said member defines a clevis pin configured to extend between the arms to couple the proximal end rotatably to the body. Preferably, the body comprises lateral side sections defining said arms.

In an alternative embodiment of the invention, the proximal end may comprise or define a clevis having laterally spaced arms, and the body comprise or define a part, e.g. a connector or fitting, arranged to be received between the arms. Said member may, in such an embodiment, define a clevis pin configured to extend between the arms to couple the proximal end rotatably to the body. Preferably, in such an embodiment, the proximal end comprises lateral side sections defining said arms.

Preferably, the arms comprise coaxial bores arranged to receive respective ones of axially spaced portions of said member such that said member is connected to the arms.

One or more embodiments of the present invention provide a linkage device for interconnecting a tensile restraint member and a structural component, the linkage device being co-operable with an attachment device which comprises a body defining a clevis having lateral side sections and an opening therebetween, the side sections being configured to receive a connecting member whereby said member extends across the opening and a central axis of a clevis pin thus defined by said connecting member is coaxial with a transverse axis,
the linkage device being configured to define a linkage having:
a proximal end receivable in the opening to be engageable with the connecting member, when the latter is received by the side sections to extend across said opening, so as to be rotatably coupled to the body such that the linkage is rotationally displaceable relative to the body about said transverse axis; and
a distal end configured such that said tensile restraint member is connectable thereto.

Preferably, the linkage device is co-operable with a said attachment device which is suitable for use with a chain having a link at an end thereof (“end link”) and, connected to and following the end link in a direction therefrom along the chain, another link (“following link”), in which attachment device the opening is configured to receive a free end of the end link, or an end of the end link opposite to that to which the following link is connected, whereby a pin member, when received by the side sections so as to extend across the opening such that a central axis of a clevis pin thus defined by the pin member is coaxial with the transverse axis, passes through said end of the end link, thus coupling the end link to the body whereby the end and following links are rotatable relative to the clevis about the transverse axis, and in which attachment device the body is configured such that:
a portion of the clevis between the side sections has a configuration complementary to a configuration of the said end of the end link; and/or
portions of the side sections have configurations which are complementary to a configuration of an end of the following link via which that link is connected to said end link,
whereby there is maintained a close fit between the clevis and said chain, and/or said complementary portions, as the end link and following link rotate relative to the clevis about said transverse axis,
wherein:
a portion of the proximal end has a configuration which conforms to that of the said/free end of the end link and/or which is complementary to that of a said portion of the clevis, whereby the portions of the proximal end and clevis are complementary; and/or
portions of the linkage have configurations which conform to a configuration/configurations of a said end of the following link and/or which are complementary to those of said portions of the side sections, whereby the portions of the linkage and side sections are complementary,
such that a close fit is maintained between the complementary portions, and/or between the linkage and the body, throughout a range of rotational displacement of the linkage about the axis.

One or more embodiments of the present invention provide a coupling device comprising said linkage device and said attachment device, the coupling device including said connecting member, wherein said proximal end is received in the opening and the connecting member is received by the side sections so as to extend across the opening such that the proximal end engages the connecting member so as to be rotatably coupled to the body via the connecting member, whereby the linkage is rotationally displaceable relative to the body about said transverse axis.

Preferably, the coupling device includes a mount configured to be secured to the structural component such that the body or device is mounted to the structural component.

In the preferred embodiments of the present invention, said fit is as close as practicably possible to being size-for-size.

Said attachment device may include said pin member.

Said linkage device may consist of said linkage.

Said connecting member may comprise said pin member.

Said connecting or pin member may comprise an elongate member-preferably a fastening member, such as a bolt-defining a pivot and/or clevis pin. Said connecting or pin member may include or be provided with a fastener or a fastening or securing element, to hold or fasten the connecting or pin member, or the elongate and/or fastening member, in place—preferably to said body or clevis.

The chain that the attachment device is, in accordance with preferred embodiments of the invention, suitable or designed to be used with is of the conventional “loop” type, comprising links defined by loops orientated at right angles one-to-the-next along the chain and having rounded ends. More particularly, the opposed ends of each link, although axially spaced apart, have the configurations of respective halves of a torus (a “doughnut shape”) defined to either side of a bisectional plane in which the central axis of the torus lies (collectively “half-tori” and each a “half-torus”), each end thus being “half-toral”.

In accordance with a preferred embodiment of the present invention, said tensile restraint member comprises a chain. Preferably said chain is of said loop type. The links of said chain may have half-toral ends dimensionally matched to those of said chain that the attachment device is suitable or designed to be used with.

In accordance with preferred embodiments of the present invention, the linkage or linkage device defines an adaptor whereby said tensile restraint member is connectable to said body or attachment device.

In accordance with preferred embodiments of the present invention, the linkage or linkage device defines a modifier providing an alternative form of connection via which said tensile restraint member is coupleable to said body or attachment device.

The tensile restraint member may comprise a said chain that the attachment device is suitable or designed to be used with.

Preferably, the device of the third aspect comprises the device of the first aspect.

In a preferred embodiment of the present invention, a portion of the clevis between said side sections has a configuration complementary to a configuration of said end of the end link.

In preferred embodiments of the present invention, said axis of the connecting member is a central axis of the connecting member.

One or more embodiments of the present invention provide an assembly comprising at least one device as recited above and at least one said structural component, and including at least one said linkage, wherein at least one said body is supported from the structural component(s) (at a respective position), and the proximal end of the or each linkage is rotatably coupled to a respective said body whereby the linkage is rotationally displaceable relative to that body about a said transverse axis.

Preferably, said at least one device as recited above comprises plural said devices, whereby the at least one linkage comprises plural said linkages and the at least one body comprises plural said bodies. Preferably, the plural devices consist of a pair of those devices, whereby the plural linkages consist of a pair of said linkages and the plural bodies consist of a pair of said bodies.

In a preferred embodiment of the present invention, the assembly includes at least one connector or fitting, connecting, or for connecting, at least one said tensile restraint member to the distal end of a respective said linkage. Preferably, said at least one connector or fitting comprises plural connectors or fittings, whereby the at least one tensile restraint member plural tensile restraint members. Preferably, said plural connectors or fittings consist of a pair of said connectors or fittings, whereby the plural tensile restraint members consist of a pair of said tensile restraint members.

Preferably, the assembly includes at least one connecting member via which a (respective) said proximal end is engaged with a (respective said) body to be rotatably coupled thereto. Preferably, the at least one connecting member comprises plural said connecting members, whereby the at least one proximal end comprises plural said proximal ends and the least one body comprises plural said bodies. Preferably, the plural connecting members consist of a pair of said connecting members, whereby the plural proximal ends consist of a pair of said proximal ends and the plural bodies consist of a pair of said bodies.

Preferably, the or each structural component is defined by or secured to a vehicle.

At least one said tensile restraint member may be arranged to be connected and/or coupled to at least one component.

Preferably, said at least one component is structural.

Preferably, said at least one component comprises at least one component other than said structural component(s) (“other component”).

Preferably, at least one said tensile restraint member is arranged to be connected to said component(s).

Preferably, said at least one component is defined by and/or secured to a vehicle.

Preferably, the vehicle comprises a support structure over or against which a load is supportable, or supported, bound by the tensile restraint member(s) in a tensioned condition, to be securely transportable by the vehicle.

The or each tensile restraint member may comprise a load-binding restraint member.

The, each, or at least one said, restraint member may comprise, for example, a strap.

The, each, or at least one said, restraint member may comprise, for example, a chain, the chain preferably being of said loop type.

The, each, or at least one said, connector or fitting may comprise, for example, one that is designed for connecting a load-binding tensile restraint member, such as a strap to part, e.g. a side rail, of a load-transportation vehicle—for instance, a hook or karabiner.

The support structure may comprise, for example, any (one or more) of a floor, a deck, a bed and a tray.

Said component(s) may be defined by or adjacent said support structure and/or secured to or adjacent the support structure.

In a preferred embodiment of the present invention, the assembly includes a support or support structure and a structure which is supported by, on or over the support/structure, and said at least one said tensile restraint member is connected to the said structure.

Said structure may be guyed by said at least one said tensile restraint member.

Said support or support structure may comprise or be defined by a foundation or slab and/or a support member secured thereto.

Said structural component may comprise or be defined by an anchor member or plate secured to a foundation or slab.

Said at least one other component may be defined by and/or secured to the structure.

Said structure may be relatively lightweight and/or be narrow or slender in a direction from said support or support structure to a part of the structure defining, or to which is/are secured, said other component(s).

In another preferred embodiment of the present invention, the structural and other components are defined by and/or secured to a said/one vehicle and another vehicle respectively.

Preferably, said one vehicle is arranged to tow or be towed by the other vehicle. Preferably, the at least one tensile restraint member comprises at least one towing safety restraint member.

Preferably, the or each towing safety restraint member comprises a towing safety chain or cable.

Preferably, said at least one towing safety restraint member is a plurality of towing safety restraint members. Preferably, said plurality of towing safety restraint members consists of a pair of said towing safety restraint members.

Preferably, the or each towing safety restraint member is connected to a respective said distal end, and is secured to the other vehicle, whereby the vehicles are interconnected via the towing safety restraint member(s). The/each towing safety restraint member may be connected to the respective distal end via one end thereof and secured to the other vehicle via the/another end thereof whereby the vehicles are interconnected via the towing safety restraint member(s).

Preferably, the other vehicle is arranged to be towed by the said vehicle, whereby the former is a towed vehicle and the latter is a towing vehicle. In that case, said one end of the or each towing safety restraint member may be a leading end and said other end a trailing end.

In a preferred embodiment of the present invention, the or each tensile restraint member comprises a chain, having a link at an end thereof (“end link”) and, connected to and following that link in a direction from the end along the chain, a link (“following link”), and the assembly includes at least one attachment or attachment device comprising a body supported from said other vehicle and defining a clevis having lateral side sections and an opening therebetween into which a free or axially outer end of the end link of a respective said chain, or an end of the end link opposite to that to which the following link is connected in a respective said chain, is received, the or each attachment or attachment device including a pin member received by the side sections, thereby extending through the respective end link and across the respective opening to couple the end link to the body whereby said end link and following link are rotatable relative to the respective clevis about a transverse axis coaxial with a central axis of a respective clevis pin thus defined by said pin member, the or each body supported from said other vehicle being configured such that:

a portion of the respective clevis between the side sections has a configuration complementary to a configuration of the respective said end of the end link; and
portions of the respective side sections have configurations which are complementary to a configuration of an end of the respective following link via which that link is connected to said end link,
whereby there is maintained a said close fit between the or each clevis and the respective chain as the end link and following link rotate relative to the clevis about said transverse axis.

Preferably, the or each attachment or attachment device is one with which a said linkage device is co-operable.

A fifth aspect of the present invention provides a kit, comprising at least one device as recited above and at least one said tensile restraint member connectable to the distal end of a respective linkage.

Preferably, said at least one device as recited above comprises plural said devices, whereby the kit includes plural said linkages, and the at least one tensile restraint member comprises plural said tensile restraint members. Preferably, the plural devices consist of a pair of said devices, whereby the plural linkages consist of a pair of said linkages.

In a preferred embodiment of the present invention, the or each said tensile restraint member comprises a chain, having a link at an end thereof (“end link”) and, connected to and following that link in a direction from the end along the chain, a link (“following link”), and the kit includes at least one attachment or attachment device comprising a body which is supportable from a said other vehicle that is arranged be towed by a said vehicle, such that the other vehicle is a towed vehicle and the said vehicle is a towing vehicle, and which defines a clevis having lateral side sections and an opening therebetween into which a free or axially outer end of the end link of a respective said chain, or an end of the end link opposite to that to which the following link is connected in a respective said chain, is receivable, the or each attachment or attachment device including a pin member receivable by the side sections thereof so as to extend across the respective opening and through the respective end link to couple the end link to the body whereby the end link and following link of the respective chain are rotatable relative to the respective clevis about a transverse axis coaxial with a central axis of a respective clevis pin thus defined by said pin member, the or each body supportable from the towed vehicle being configured such that:
a portion of the respective clevis between the side sections has a configuration complementary to a configuration of the respective said end of the end link; and
portions of the respective side sections have configurations which are complementary to a configuration of an end of the respective following link via which that link is connected to said end link,
whereby there is maintained a said close fit between the or each clevis and the respective chain as the end link and following link rotate relative to the clevis about said transverse axis.

Preferably, said at least one attachment or attachment device comprises plural said attachments or attachment devices. Preferably, the plural attachments or attachment devices consist of a pair of said attachments or attachment devices.

Preferably, said kit includes at least one said connector or fitting whereby the end of a respective said tensile restraint member is connectable to a respective said distal end via that connector or fitting.

Preferably, said kit includes at least one said connecting member, the proximal end of the or each linkage being rotatably coupleable, via a respective said connecting member, to the respective body supportable from the structural component.

The said device as recited above may be a said coupling device or a said linkage device.

Preferably, the said vehicle is a/the towing vehicle. Alternatively, the said vehicle may be a/the towed vehicle.

The towing vehicle may be locomotively powered.

The towing vehicle may be a prime mover.

The towing vehicle may be a heavy haulage vehicle.

The towing vehicle may be a lorry or truck, such as, for example, a tractor truck.

The towed vehicle may be unpowered.

The towed vehicle may be a trailer, such as, for example, a semi-trailer, pup trailer or tractor trailer.

The towing vehicle may be a hauled vehicle, such as (for example) a semi-trailer, pup trailer or other trailer, arranged to be towed by a locomotively powered vehicle (such as, for example, a prime mover) and to tow another vehicle (such as, for example, a semi-trailer, pup trailer or other trailer) which constitutes a said towed vehicle. In accordance with an embodiment of the invention that is exemplary in this regard, there is provided a road train, land train or long combination vehicle (LCV), comprising a prime mover and trailers/semi-trailers which are serially coupled one-to-another and include or consist of one trailer/semi-trailer/pup trailer and, arranged therebehind and coupled thereto, another trailer/semi-trailer/pup trailer, wherein said one trailer/semi-trailer/pup trailer is a towing vehicle and the other a towed vehicle.

In accordance with a preferred embodiment of the invention, said coupling device includes a mount configured to be secured to the structural component such that the body or device is mounted to the structural component. Preferably, the coupling device comprises a base defining said mount.

The mount or base may be defined by the body. Alternatively, the coupling device may, for example, include a mounting flange or plate attached or attachable to the body and configured to be secured to the structural component to mount the body or device.

Preferably, the mount or base comprises a face lying in a plane parallel said axis and securable against a surface of the structural component. Preferably, the face is flat, being securable against a said surface of the structural component that is flat.

In accordance with a preferred embodiment of the present invention, said surface is forwardly or rearwardly facing. The surface may, where the said vehicle is a said towing vehicle, be rearwardly facing (relative to a direction of forward travel of the vehicle). The surface may be, where the said vehicle is a said towed vehicle, be forwardly facing (relative to a direction of forward travel of the said vehicle).

In accordance with an alternative such embodiment, said surface is upwardly or downwardly facing. Preferably, the upwardly or downwardly facing surface is downwardly facing.

Preferably, an extent to which the linkage is rotatable relative to the body is such that a portion of the linkage can lie in said plane so as to abut the surface to transfer through it forces towards the structural component that are exerted on the linkage while not loaded.

Devices in embodiments of the invention will typically be configured and arranged such that (where the body is supported from the structural component) the transverse axis, being an axis that is transverse, and preferably perpendicular, to a direction from the proximal end to the distal end, is substantially parallel to a width dimension of the structural component.

In the preferred embodiments of the invention, the proximal end comprises or defines a connector or fitting engageable with a said connecting member to be rotatably coupled to the body via the connecting member.

In the preferred embodiments of the invention, the distal end comprises or defines a connector or fitting engageable by a connector or fitting of/attached to the tensile restraint member to interconnect the tensile restraint member and structural component.

Said range may comprise or encompass a full extent of rotational displaceability of the linkage or rotational displacement (particularly in/during use) of the linkage (though need not necessarily comprise/encompass the entirety of said extent).

Said range and/or said extent may be through/be at least 30 degrees (or thereabout).

Said range and/or said extent may be through/be at least 45 degrees (or thereabout).

Said range and/or said extent may be through/be at least 60 degrees (or thereabout).

Said range and/or said extent may be through/be at least 75 degrees (or thereabout).

Said range and/or said extent may be up to 120 degrees (or thereabout).

Said range and/or said extent may be up to 135 degrees (or thereabout).

In a preferred embodiment of the invention, said range and/or said extent are/is 90 degrees (or thereabout).

A said device as recited above may be, and in a preferred embodiment is, configured such that a rest position of the linkage, when said proximal end thereof is rotatably coupled to the body and the body is supported from the structural component, may be between (rather than at either of) opposite limits or extremities of said range and/or said extent. The rest position may be a position assumed by the linkage when not loaded, and/or when not dynamically loaded by the tensile restraint member and connector/fitting connecting the tensile restraint member to the linkage.

In accordance with the present invention or one or more preferred embodiments thereof, said coupling device is supported or supportable from the structural component.

In accordance with the present invention or one or more preferred embodiments thereof, said body is supported or supportable from the structural component.

Preferably, the coupling device or said attachment device includes a mount secured or securable to the structural component such that the body or device is mounted to the structural component.

Preferably, the distal end is configured such that said structural component is releasably connectable thereto.

Preferably, the body is of unitary or single-piece construction.

Preferably, the complementary portions comprise transversely complementary portions-which portions are preferably complementary parallel to said axis. Preferably the complementary portions comprise circumferentially complementary portions.

Preferably, the complementary portions comprise a portion of the proximal end that is convex about an axis (which may be an axis through the linkage) arranged to be coaxial with the transverse axis and a portion of the body that is concave about said transverse axis so as to conform closely to the convex portion. Preferably, the convex and concave portions conform to (complementary) tori. Preferably, the convex portion is half-toral.

In a preferred embodiment, the proximal end comprises an edge which has a profile that is transversely convex, or which is radially outwardly arcuate, therealong, such that a portion of the body which has a transversely concave profile, or which defines a channel that is radially outwardly arcuate therealong, conforms to the edge, whereby the complementary portions comprise the edge and the portion having said transversely concave profile or defining the radially outwardly arcuate channel.

In a preferred embodiment of the invention, the concave portion is defined between said arms or side sections.

Preferably, the complementary portions comprise a portion defined by an edge of the linkage or proximal end thereof (such as an end of the linkage or end thereof arranged to be adjacent said structural component) which has a profile that is (preferably semicircularly) convex transversely (and preferably parallel to said axis), or which (preferably parallel to said axis) is (preferably circularly) radially outwardly arcuate, therealong, and a portion of the body which has a concave profile transversely (preferably parallel to said axis), or which defines a channel that (preferably parallel to said axis) is (preferably semicircularly) radially outwardly arcuate therealong, so as to conform to the edge. In a preferred embodiment of the invention, the portion of the body having a transversely concave profile (preferably semicircularly) or defining a (preferably semicircularly) radially outwardly arcuate channel is defined between said arms or side sections.

In a preferred embodiment of the invention, said convex portion is defined by said edge, and said concave portion is defined by the portion having a transversely concave profile or defining a radially outwardly arcuate channel.

Preferably, the proximal end includes an aperture or bore arranged to receive a said member, or a pin or connecting member, therethrough such that the proximal end is rotatably coupled to the body.

Preferably, the linkage comprises a proximal link defining the proximal end.

In a preferred embodiment of the invention, said proximal link is arranged to engage a said member whereby the proximal end is rotatably coupled to the body.

In a preferred embodiment of the invention, said proximal link defines said aperture or bore.

Preferably, the complementary portions comprise laterally opposed portions of the body or side sections and laterally opposed portions of the linkage profiled to conform to respective ones of the laterally opposed portions of the body or side sections. In a preferred embodiment of the invention, said laterally opposed portions of the body or side sections extend circumferentially (in a direction of rotation about said axis). In some embodiments, the complementary portions comprise laterally opposed portions of the linkage and body or side sections

In the preferred embodiments of the invention, the complementary portions conform/are configured to conform to respective complementary tori.

Preferably, said laterally opposed portions of the linkage are profiled to conform circumferentially to the laterally opposed portions of the body or side sections. The laterally opposed portions of the linkage may be circumferentially (preferably semicircularly) arcuate whereby to be so profiled.

Preferably, said laterally opposed portions of the linkage are profiled to conform transversely (preferably parallel to said axis) to the laterally opposed portions of the body or side sections. In accordance with a preferred embodiment of the invention, the laterally opposed portions of the linkage have convex profiles transversely (preferably parallel to said axis) and the laterally opposed portions of the body or side sections have complementarily concave profiles transversely (preferably parallel to said axis). In accordance with another such embodiment, the laterally opposed portions of the linkage have concave profiles transversely (preferably parallel to said axis) and the laterally opposed portions of the body or side sections have complementarily convex profiles transversely (preferably parallel to said axis). In accordance with another such embodiment, the laterally opposed portions of the linkage have angled or diagonal profiles transversely (preferably parallel to said axis) and the laterally opposed portions of the body or side sections have complementarily angled or diagonal profiles transversely (preferably parallel to said axis).

Preferably, the laterally opposed portions of the linkage are distally outwardly divergent.

Preferably, the laterally opposed portions of the linkage are defined by a region or interconnection between the proximal and distal ends or respective links defining those ends.

Preferably, the laterally opposed portions of the linkage are defined by shoulders.

Preferably, the linkage comprises a distal link defining the distal end, the distal link being engageable by a connector or fitting of or attached to the tensile restraint member such that the tensile restraint member is releasably connected thereto via the connector or fitting.

Preferably, the linkage is of unitary or single-piece construction.

The linkage may be cast or forged.

Preferably, the distal end includes a bar portion, arranged to extend between, or from one to the other of, opposed lateral sides thereof, over and/or around which a connector or fitting of or attached to the tensile restraint member is receivable so as to connect the towing tensile restraint member thereto.

Preferably, the linkage includes a ring or loop portion, defining the distal end, over or around which a portion a/the connector or fitting of/attached to the tensile restraint member is receivable so as to connect the tensile restraint member thereto. In a preferred embodiment of the present invention, the loop or ring portion defines said bar portion.

Preferably, the ring or loop portion is arranged such that a width dimension of an opening bounded thereby extends parallel to said axis.

Preferably, the ring or loop portion is distally divergent.

Preferably, the ring or loop portion defines an ovate or rounded triangular shape orientated such that a base thereof is at said distal end and a vertex or apex thereof is adjacent said proximal end.

Preferably, the linkage defines opposing regions each of which has opposite faces convergent towards a plane passing through the opposing regions, such that each region is of reducing thickness in a direction towards the other, whereby respective ones of the faces of said regions to opposite sides of said plane are abuttable by respective opposing regions of a connector or fitting of/attached to the tensile restraint member, defined around the connector or fitting, upon the connector or fitting being displaced to a sufficient extent in either rotational direction about an axis which extends between distal and proximal ends of the connector or fitting and/or lengthways along the tensile restraint member and through the connector or fitting. Advantageously, in preferred embodiments of the present invention, the connector or fitting thus can be (before fouling against the linkage), rotationally displaced, from a mean or central rotational position it assumes relative to a section of the linkage around which it is received, to a greater extent than if the linkage were not formed with the regions of reducing thickness.

In some embodiments, the opposing regions or regions of reducing thickness comprise regions defined by and along opposed lateral side portions of the linkage each of which extends in a direction from said proximal end and towards said distal end.

In preferred embodiments of the present invention, said opposing regions or regions of reducing thickness comprise regions defined:
by and around a said ring or loop portion; and/or
by and along a said bar portion; and/or
by and around, and/or along, a said distal link; and/or
by and along opposed lateral side portions of the linkage, ring or loop portion, or distal link each of which lateral sides extends in a direction from said proximal end towards said distal end.

Preferably, the linkage is configured such that a width dimension of a said opening therethrough extends transversely (preferably parallel to said axis). The opening may be one that is bounded by a said ring or loop portion and/or by a said bar portion and/or by a said distal link and/or by opposed lateral side portions of the linkage, ring or loop portion, or distal link each of which lateral side portions extends in a direction from said proximal end towards said distal end.

In accordance with a preferred embodiment of the present invention, a said linkage or linkage device is orientated or arranged such that it projects from said structural component in a direction which is or is opposite to, or which has a directional component in or opposite to, a direction of loading exerted on or by either the structural component or a structure which defines or to which is secured the structural component, by or on, respectively, either another component or a structure which defines or to which is secured another component, via a coupling between the components, the other component being connected or coupled to said structural component via said tensile restraint member—preferably whereby said distal end is prominent (e.g. arranged to be exposed and/or remote from said structural component) for connection of the tensile restraint member thereto. Preferably, said linkage or linkage device is orientated or arranged to project in said direction in a said rest position.

Where the structural component is arranged to exert said loading on the other component, the linkage or linkage device is preferably orientated or arranged such that it projects from the structural component in a said direction which is opposite to, or which has a directional component opposite to, the direction of the loading.

Where the other component is arranged to exert said loading on said structural component, the linkage or linkage device is preferably orientated or arranged such that it projects from the structural component in a said direction which is, or which has a directional component in, the direction of the loading.

Preferably, the direction from the structural component has said directional component and a component in an upwards or downwards direction.

Preferably, said component in an upwards or downwards direction is a component in a downwards direction.

Preferably, a plane in which said axis lies and which extends in said direction from the structural component forms an acute angle with a vertical or (otherwise) upright plane in which said axis lies or which is parallel to said axis. In accordance with a preferred embodiment of the present invention, said face lying in a plane parallel said axis and securable/secured against a surface of said structural component is arranged to define said vertical or upright plane.

Said angle may be between 15 degrees or thereabout and 75 degrees or thereabout. Preferably, said angle is between 30 degrees or thereabout and 60 degrees or thereabout. Preferably, said angle is 45 degrees or thereabout.

In accordance with a preferred embodiment of the present invention, a said device includes a retainer configured to support the linkage (preferably against gravity) whereby it so projects in said direction from said structural component.

In accordance with a preferred embodiment of the present invention, the retainer comprises a (preferably removable) spacer (directly or indirectly) coupled, preferably pivotably and/or at a proximal end or portion thereof, to the linkage and arranged to engage (directly or indirectly) said structural component or said surface, preferably via a distal end or portion thereof, to support the linkage such that it projects in said direction from said structural component.

In accordance with a preferred embodiment of the present invention, the linkage is resiliently biased, preferably against gravity and/or by at least one resiliently biasing part or member, so as to project in said direction from said structural component.

A said coupling or linkage device may, in accordance with a preferred embodiment of the present invention, include at least one resiliently biasing part or member (preferably defined by a said spacer), via which the spacer and the linkage are interengaged, to bias the spacer resiliently such that the linkage projects in said direction from said structural component.

One or more embodiments of the invention provides an assembly comprising at least one device described above and at least one said structural component, and including at least one said linkage, wherein at least one said body is supported from the structural component(s), and the proximal end of the or each linkage is rotatably coupled to a respective said body whereby the linkage is rotationally displaceable relative to that body about a said transverse axis

The assembly according to a preferred embodiment of the present invention comprises at least one other component/said other component(s), and including at least one coupling between the structural and other components via which loading is or can be exerted by either of the former and latter components on the other of said former and latter components, wherein the structural and other components are interconnected or coupled via at least one said tensile restraint member.

Preferably, the assembly includes at least one connector or fitting connecting, or for connecting, at least one said tensile restraint member to the distal end of a respective said linkage.

Preferably, the assembly includes at least one connecting member via which a (respective) said proximal end is engaged with a (respective) said body to be rotatably coupled thereto.

Preferably, the assembly includes at least one other component/said other component(s), and includes at least one coupling between the structural and other components via which loading is or can be exerted on or by the structural component(s) or a structure which defines or to which is/are secured said structural component(s), by or on, respectively, the other component(s) or a structure which defines or to which is/are secured said other component(s), wherein the structural and other components are interconnected or coupled via at least one said tensile restraint member.

Preferably, the assembly includes a support structure on which there is supported a load, wherein said at least one said tensile restraint member engages the load to hold it to/against the support structure.

Preferably, the support structure comprises any of a floor, a deck, a bed and a tray.

Preferably, the or each tensile restraint member comprises a belt or strap.

Preferably, the assembly includes a support or support structure and a structure which is supported by, on or over the support/structure, wherein said at least one said tensile restraint member is connected to the said structure.

Preferably, the said structure is guyed by said at least one said tensile restraint member.

Preferably, said support or support structure comprises or is defined by a foundation or slab and/or a support member secured thereto.

Preferably, said structural component comprises or is defined by an anchor member or plate secured to a foundation or slab.

Preferably, said at least one other component is defined by and/or secured to the structure.

Preferably, said at least one other component or structure which defines or to which is/are secured said other component(s) is arranged to draw or be drawn by the at least one structural component or structure which defines or to which is/are secured said structural component(s), by means of said loading.

Preferably, the or each structural component is defined by or secured to one vehicle and the at least one other component is defined by or secured to another vehicle arranged to tow or be towed by said one vehicle.

Preferably, the or each coupling/linkage device is as described above, and the or each tensile restraint member comprises a chain, having a link at an end thereof (“end link”) and, connected to and following that link in a direction from the end along the chain, another link (“following link”), the assembly including at least one attachment or attachment device comprising a body secured to the other component(s) and defining a clevis having lateral side sections and an opening therebetween into which a free or axially outer end of the end link of a respective said chain, or an end of the end link opposite to that to which the following link is connected in a respective said chain, is received, the or each attachment or attachment device including a pin member received by the side sections, thereby extending through the respective end link and across the respective opening to couple the end link to the body whereby said end link and following link are rotatable relative to the respective clevis about a transverse axis coaxial with a central axis of a respective clevis pin thus defined by said pin member, the or each body secured to said other component(s) being configured such that:
a portion of the respective clevis between the side sections has a configuration complementary to a configuration of the respective said end of the end link; and
portions of the respective side sections have configurations which are complementary to a configuration of an end of the respective following link via which that link is connected to said end link,
whereby there is maintained a said close fit between the or each clevis and the respective chain as the end link and following link rotate relative to the clevis about said transverse axis.

Preferably, the or each attachment or attachment device is one with which a linkage is co-operable.

Disclosed herein is a kit, comprising:
at least one device as described above; and
at least one said tensile restraint member,
wherein the or each tensile restraint member is connectable to the distal end of a respective linkage.

Preferably, the or each coupling/linkage device is as described above and the or each body is adapted to be supported from said structural component(s) defined by or secured to one vehicle, and the or each tensile restraint member comprises a chain, having a link at an end thereof (“end link”) and, connected to and following that link in a direction from the end along the chain, a link (“following link”), the kit including at least one attachment or attachment device comprising a body which is securable to at least one other component defined by or arranged to be secured to another vehicle, such that the other vehicle is a towed vehicle and said one vehicle is a towing vehicle, and which defines a clevis having lateral side sections and an opening therebetween into which a free or axially outer end of the end link of a respective said chain, or an end of the end link opposite to that to which the following link is connected in a respective said chain, is receivable, wherein the or each attachment or attachment device includes a pin member receivable by the side sections thereof so as to extend across the respective opening and through the respective end link to couple the end link to the body whereby the end link and following link of the respective chain are rotatable relative to the respective clevis about a transverse axis coaxial with a central axis of a respective clevis pin thus defined by said pin member, and wherein the or each body securable to the other component(s) defined by or arranged to be secured to the other vehicle is configured such that:
a portion of the respective clevis between the side sections has a configuration complementary to a configuration of the respective said end of the end link; and
portions of the respective side sections have configurations which are complementary to a configuration of an end of the respective following link via which that link is connected to said end link,
whereby there is maintained a said close fit between the or each clevis and the respective chain as the end link and following link rotate relative to the clevis about said transverse axis.
   Preferably, the kit includes at least one said connector or fitting whereby a respective said tensile restraint member is connectable to a respective said distal end via that connector or fitting.
   Preferably, the kit includes at least one said connecting member, wherein the proximal end of the or each linkage is rotatably coupleable, via a respective said connecting member, to the respective body adapted to be supported from the said structural component(s).

Said at least one coupling may comprise the at least one said tensile restraint member arranged to assume a tensioned condition to take said loading therethrough.

Said at least one coupling may comprise the at least one said tensile restraint member arranged to assume a tensioned condition which is such that it restrains either of said former and latter components against being disconnected or decoupled from the other of said former and latter components in the case of failure of the said coupling.

Preferably, the at least one other component, or a structure which defines or to which is secured said at least one other component, is arranged to draw or be drawn by the at least one structural component, or a structure which defines or to which is secured said at least one structural component, by means of said loading.

Preferably, the or each structural component is defined by or secured to one vehicle (or a said structure defined thereby) and the at least one other component is defined by or secured to another vehicle, or a said structure defined by another vehicle, which other vehicle is arranged to tow or be towed by said one vehicle (by means of the drawing/loading).

In the preferred embodiments of the invention, the linkage or linkage device is defined by a stirrup.

### BRIEF DESCRIPTION OF THE DRAWINGS

Preferred embodiments of the invention will now be described, by way of non-limiting example, with reference to the accompanying drawings, in which:

FIG. 1, discussed above, shows known means of providing a primary/in-service mechanical connection between a towing vehicle and towed vehicle, and of providing a secondary/retaining mechanical connection between the vehicles in the event of a failure of the former connection;

FIG. 2 is a side elevation view showing coupling of a safety chain (connected to a towed vehicle) to a towing vehicle via a coupling device, or “coupler”, according to a preferred embodiment of the present invention;

FIG. 3 is a partially exploded perspective view showing a body, a pivot connector (comprising a connecting/pin member) and a linkage (defined by a linkage device) of the coupler, and a connector (comprising a sling hook) for connecting the chain to the coupler;

FIG. 4 is a side elevation view of the coupler;

FIG. 5 is a perspective view of the coupler;

FIG. 6 is a rear elevation view of the body;

FIG. 7 is a front elevation view of the body;

FIG. 8 is a cross-sectional view of the linkage shown in FIG. 4 along the line A-A;

FIG. 9 is a front view of the linkage;

FIG. 10 is a rear view of the linkage;

FIG. 11 is a side elevation view of the linkage;

FIG. 12 is a section view of the linkage shown in FIG. 9 along the line B-B;

FIG. 13 is a plan view of the linkage;

FIG. 14 is a bottom view of the linkage;

FIG. 15 is a cross-sectional view of the linkage takin along the line C-C in FIG. 11;

FIG. 16 is a cross-sectional view, taken along the line D-D in FIG. 7, showing details of the body, in a plane between opposed lateral sides thereof;

FIG. 17 is a perspective view showing a body of/for a coupler according to another preferred embodiment of the present invention;

FIG. 18 is a perspective view showing the body illustrated in FIG. 17 connected to links of a safety chain (rather than to said linkage);

FIG. 19 is a side elevation view showing the body and links illustrated in FIGS. 17 and 18, indicating an extent to which the body permits rotational displacement of links connected thereto;

FIG. 20 is a side view of a pivot connector of/for a coupler according to another preferred embodiment of the present invention;

FIG. 21 is a plan view of the pivot connector shown in FIG. 20;

FIG. 22 shows a component comprising a base and a body of/for a coupler according to another preferred embodiment of the present invention;

FIG. 23 is a front view of the component;

FIG. 24 shows displaceability of the connector (connected to the distal link) around the distal link and/or about an axis extending through (and transverse/perpendicular to) an opening bounded by the distal link;

FIG. 25 shows rotational displaceability of the connector (connected to the distal link) about an axis which extends between distal and proximal ends of the connector and/or in a length direction of the chain;

FIG. 26 shows rotational displaceability of the linkage or linkage device relative to the body about a transverse axis coaxial with a central axis of said connecting/pin member;

FIG. 27 shows cross-sectional profiles of respective welds via which the body may be attached or secured to a structural component defined by or supported from the vehicle;

FIG. 28 is a side perspective view of a linkage (defined by a linkage device) according to another preferred embodiment of the present invention;

FIG. 29 is a perspective view showing the linkage illustrated in FIG. 28 and a pivot connector (comprising a connecting/pin member) in accordance with another preferred embodiment of the present invention;

FIG. 30 is another perspective view showing the linkage and pivot connector illustrated in FIG. 29;

FIG. 31 is a side perspective view of a coupler, including the linkage and pivot connector illustrated in FIGS. 29 and 30 and a resiliently flexible spacer or upstand for spacing the linkage from and/or orientating it relative to a structural component defined by or supported from the vehicle, according to a preferred embodiment of the present invention;

FIG. 32 is a perspective view of a torsional spring element defining the spacer/upstand in the coupler shown in FIG. 31;

FIG. 33 is a side elevation view showing coupling of a load-binding/securing strap to a support structure, via a coupling device or coupler, in accordance with a preferred embodiment of the present invention; and

FIG. 34 is a side elevation view showing coupling of a guy wire or cable to a support structure, via a coupling device or coupler, in accordance with a preferred embodiment of the present invention.

### DETAILED DESCRIPTION OF THE PREFERRED EMBODIMENTS

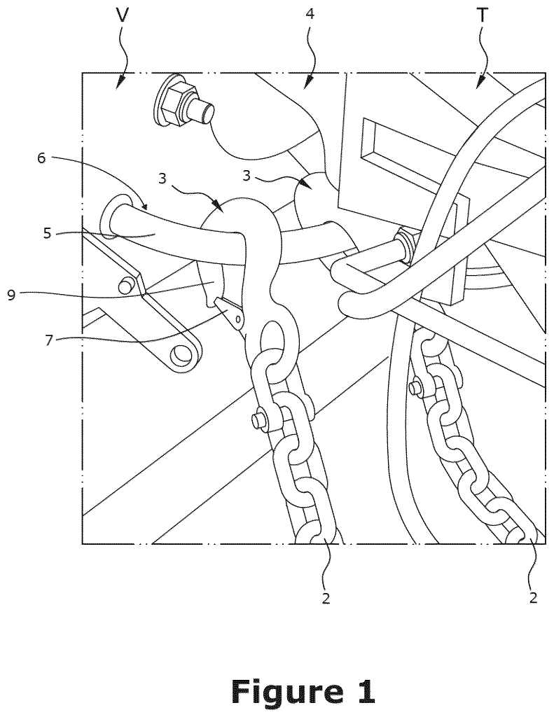

In the forthcoming description of embodiments of the invention and the associated drawings, certain reference numerals as have been used in the Background above and FIG. 1 of the drawings are used in respect of the same or corresponding features.

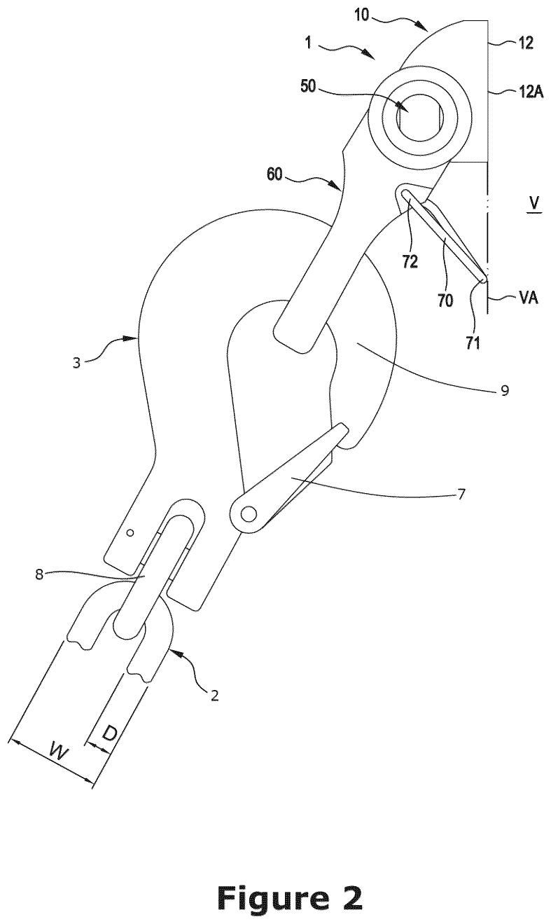

Shown in FIGS. 2 to 5 is a coupler 1 for coupling a tensile restraint member, which in the case of the present embodiment comprises a safety chain 2, to a structural component, which in the case of the present embodiment is defined by or secured to a vehicle V and may comprise, for example, any of (inter alia) a frame or beam member, a towbar, a hitch and a bracket. The coupler 1 comprises a body 10, securable to the structural component/vehicle V to mount the coupler 1 to the vehicle V, a connecting member comprising a pivot connector 50 connected to the body 10, and a linkage device 60 defining a linkage connected to the pivot connector 50 so as to be coupled to the body 10 via the pivot connector 50 whereby the linkage 60 is rotatably displaceable or swingable relative to the body 10 about a lateral/transverse axis A1 (see FIGS. 9 to 12 and 16) along which the pivot connector 50 extends. The linkage 60 is engageable with a fitting or connector 3, comprising a sling hook or karabiner hook, connected to a link 8 at an end of the chain 2, such that the chain 2 is connected (via link 8 and hook 3) to the linkage 60 (and thus, indirectly, to the coupler 1), so as to be coupled to the vehicle V. Alternative connectors or fittings (other than the connector comprising a sling hook or karabiner hook 3), connected to link 8, (e.g. an S-hook) may (without departure from the invention) be provided to be engaged by the linkage 60 whereby the chain 2 is connected to the linkage 60.

The chain 2 is secured, or to be secured, at its opposite end to another vehicle T arranged to be towed by the vehicle V, whereby the vehicles are interconnected via the chain C. That the other vehicle T is arranged to be towed by the vehicle V—whereby the former is a “towed vehicle” and the latter a “towing vehicle”—is generally preferred, given that regulations in a number of countries mandate that a releasable safety chain (or cable)-vehicle coupling (which is the kind of coupling the linkage 60 provides in accordance with the present embodiment and other embodiments of the invention) be between the safety chain/cable and the towing vehicle, though the vehicles V and T may instead be towed and towing vehicles, respectively, without departure from the invention.

The/each chain 2 may be one that is compliant with Australian Standard 2321-2006, entitled “Short-link chain for lifting purposes”, which is hereby incorporated herein by reference in its entirety, in which case the connector should be likewise compliant or (in any event) rated to the chain (as should each and every other load-bearing constituent in the connection/coupling (between the two vehicles) of which each of the connector and chain forms a part). Grade-80 chain is, at any rate, generally preferred.

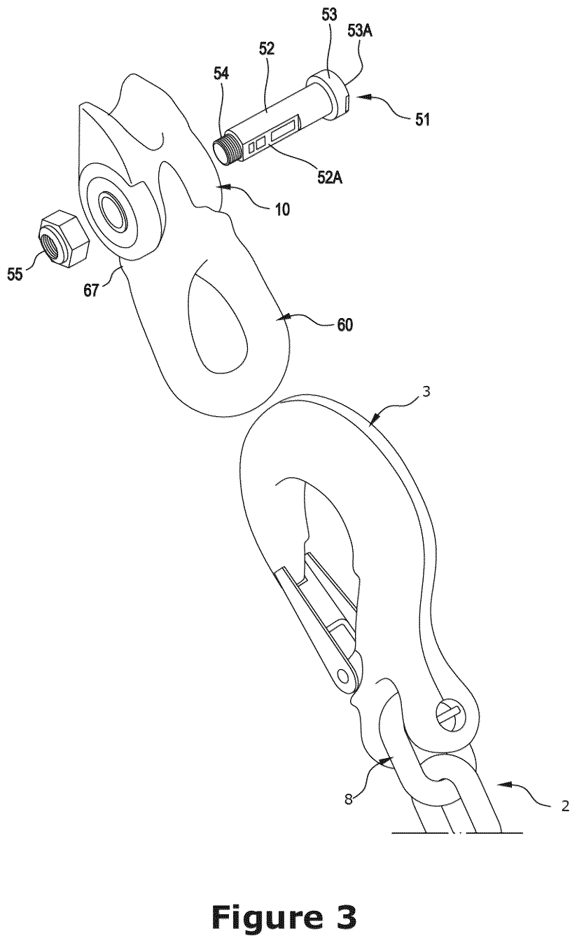

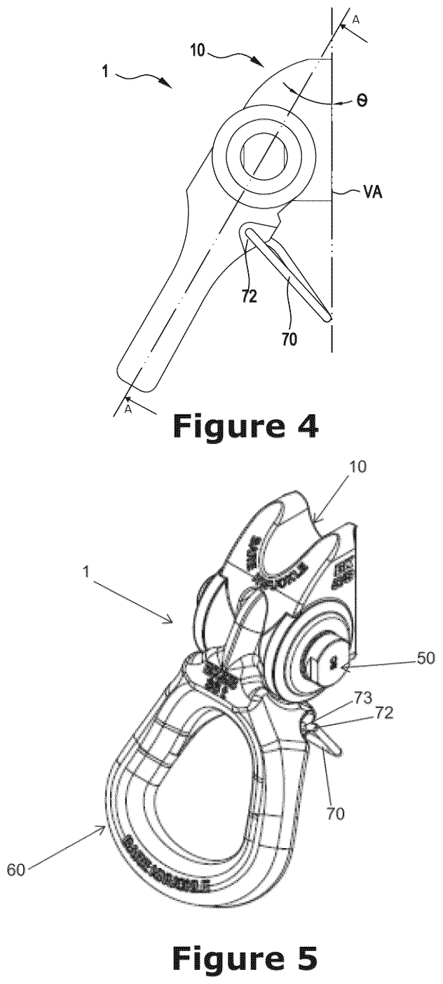

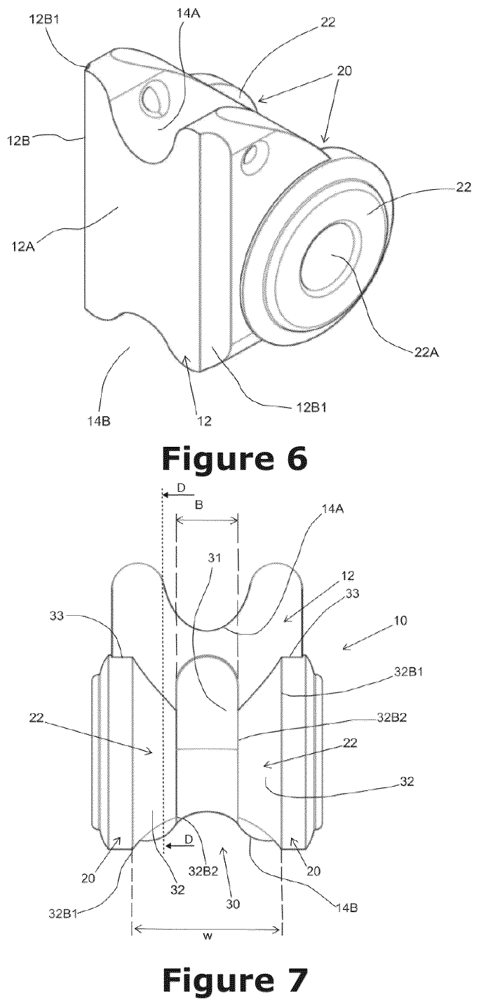

The body 10, referring additionally to FIGS. 6 and 7, has a base 12 securable against the structural component/vehicle V such that the body 10/coupler 1 is mounted to the structural component/vehicle V; see FIGS. 2 and 4. More particularly, the base 12 comprises a substantially flat face 12A receivable against a corresponding flat surface or face VA of the structural component V and a perimeter 12B along and around which it can be welded to the face VA (by any suitable method, such as MIG or arc welding). The face or surface VA may, for example, be a rearward facing upright surface or a downward facing/underside surface. To be affixed to the surface VA, the body 10 is welded to the surface VA around a perimeter of its base 12.

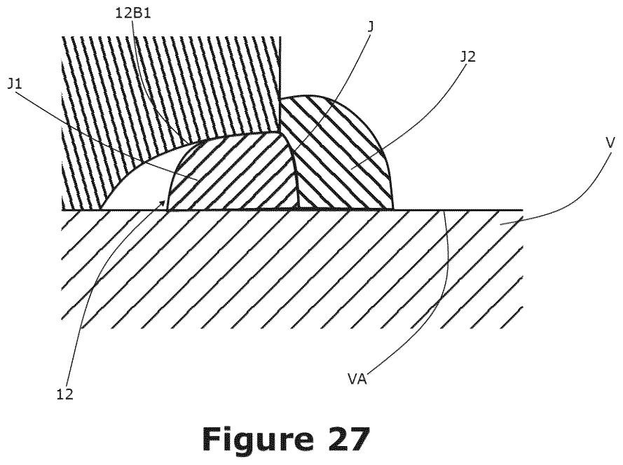

The body 10 has recessed portions 40, 41 at opposite ends. Advantageously, this allows a greater perimeter at the base 12, thereby permitting a longer weld join, without increasing the footprint thereof and without appreciably compromising the load transfer properties/capacity of the body 10. The base 12 includes opposed lateral side edges 12B1, each of which forms part of the perimeter 12B and is bevelled-whereby at each lateral side of the base 12, referring to FIG. 27, the weld join J comprises a weld J1 between the respective edge 12B1 and the surface VA and may (if desirable or appropriate having regard to duty or service requirements of the coupler 1 or loading conditions) additionally comprise a weld J2 between the surface VA and the weld J1/respective lateral side face of body 10 or base 12 adjacent the edge 12B1. The body 10 has upper 14A and lower 14B arcuate recesses, defined by downwardly curving upper and upwardly curving lower surfaces respectively thereof, which open through the base 12/face 12B, contributing to the overall length of the perimeter 12B, and thus the length of the weld join therearound/therealong (and, in turn, the strength of the connection of the body 10/coupler 1 to the structural component/vehicle V, without increasing—indeed, while decreasing—the footprint of the body 10/base 12, and without appreciably compromising the load transfer properties/capacity of the body 10.

The body 10 defines a clevis, comprising laterally opposed sides 20 including respective arms 22 each having an aperture or hole 22A extending therethrough, the apertures/holes 22A being concentric about the transverse/central lateral/horizontal axis A1 which is parallel to a plane in which the face 12A lies. Each arm 22 defines a respective boss.

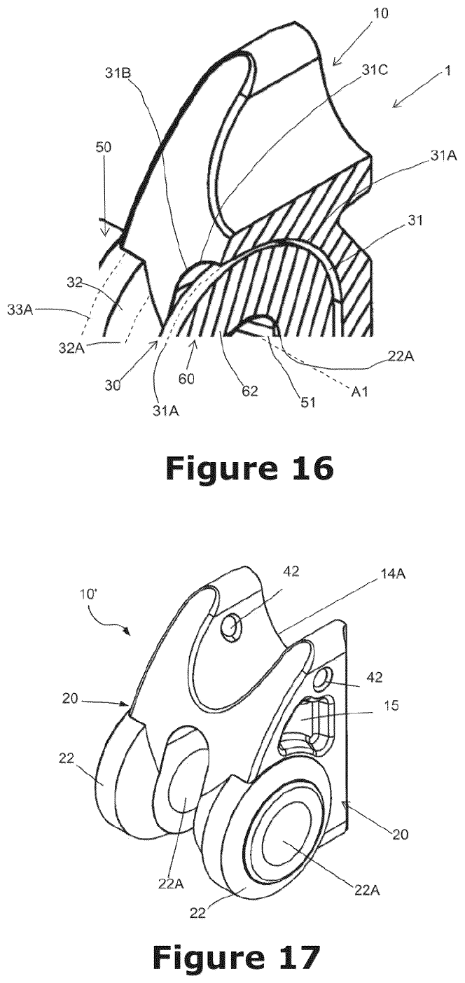

The body 10 includes a region 30, configured such that the linkage 60 seats (slidably) thereagainst or is clear thereof, forming in either case a close fit therewith, the region 30 being centrally disposed with respect to the sides 20 and base 12. The region 30 includes a first or inner surface portion 31, a left half of which can be seen in FIG. 16, and second or intermediate surface portions 32, provided on or defined by respective bosses 22 and converging (radially) towards axis A1 in a laterally inward direction, the portions 31 and 32 defining a contoured slot. The region 30 further includes third or outer surface portions 33, which extend laterally outwardly from the laterally outer ends of the portions 32 and may conform to the surface of an imaginary cylinder centred on/along axis A1.

The portion 31 conforms to an arc 31A which is circular about axis A1, thus being, or defining a profile which is, concave about that axis. The portion 31 is, throughout the extension thereof along that arc (which may be through 180° or through a smaller angle), transversely curved in a plane which passes through the arc 31A and in which axis A1 lies, from one to the other of opposed lateral sides 31B thereof, thus being, or defining a profile 31C which is, concave in the plane.

Each of the portions 32 conforms to a respective arc 32A which is circular about axis A1 and is, throughout the extension of the portion 32 along that arc (which in the examples shown is through an angle greater than 180°), transversely curved in a plane which passes through the arc 32A and in which axis A1 lies, from one to the other of laterally outer 32B1 and inner 32B2 sides thereof. Each of the portions 33 conforms to a respective arc 33A which is circular about axis A1 and is, throughout the extension of the portion 33 along that arc (which in the examples shown is through an angle greater than 180°), flat or straight in a plane which passes through the arc 33A and in which axis A1 lies, from one to the other of laterally outer 33B1 and inner 33B2 sides thereof (though which in other embodiments may, for instance, be curved, e.g. convex or concave, in said plane).

The pivot connector 50, referring to FIGS. 2 to 5, comprises a bolt 51 having a smooth shank section 52, provided along a portion thereof with opposed flattened portions or flats 52A, a round head 53, likewise provided with opposed flattened portions or flats 53A, and a threaded shank section 54 at a leading end of the bolt 51, as well as a threaded nut 55, engageable with the threaded section 54. When the bolt 51 is received in the body 10/bosses 22, and secured thereto/therein by tightening of the nut 55 at the threaded section 54 (which can be facilitated by gripping of the head 53 with a spanner via the flats 53A), the smooth shank section 52 defines a pivot or clevis pin for engaging the linkage 60, such that the linkage device 60 is, as shown in FIG. 26, rotatably displaceable around the pin 52, and thus about the central axis A1, to be swingable or pivotable relative to the body 10 about that axis.

It will be appreciated that the leading end of the bolt 51 may, alternatively or additionally, be secured other than by means of nut 55—e.g. via a circlip or similar fastening—without departure from the invention.

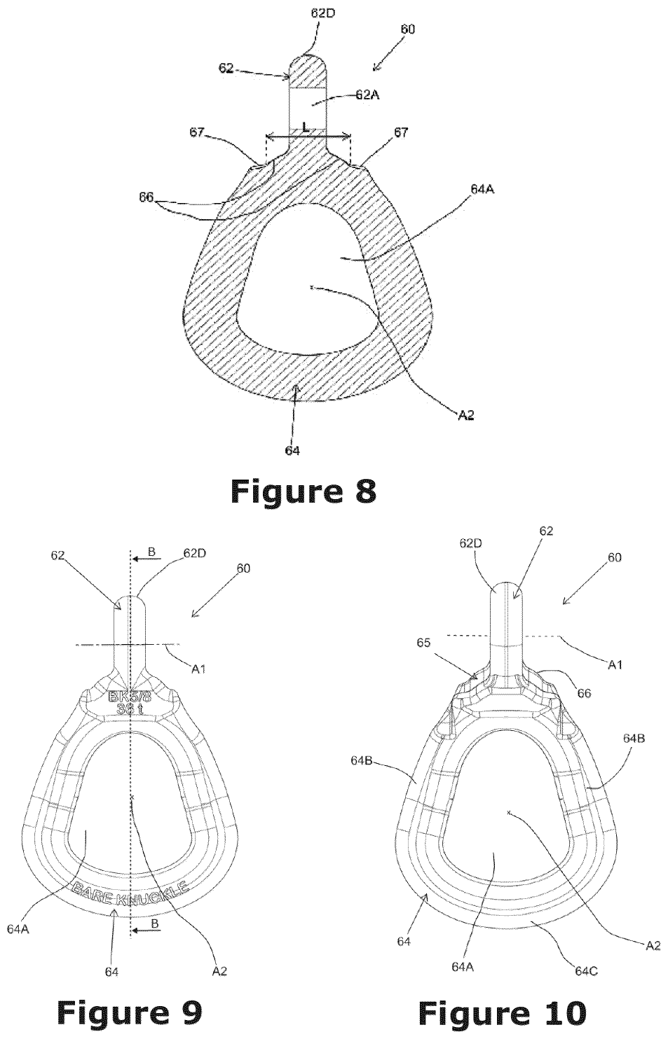

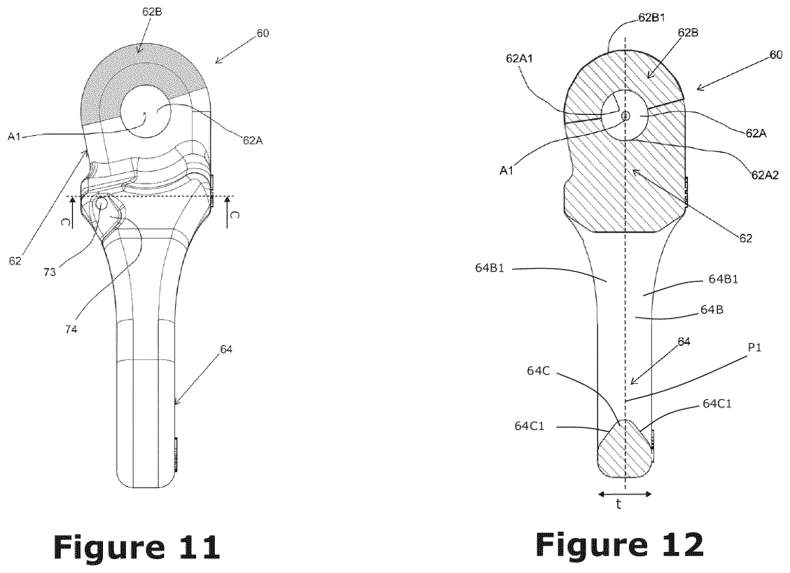

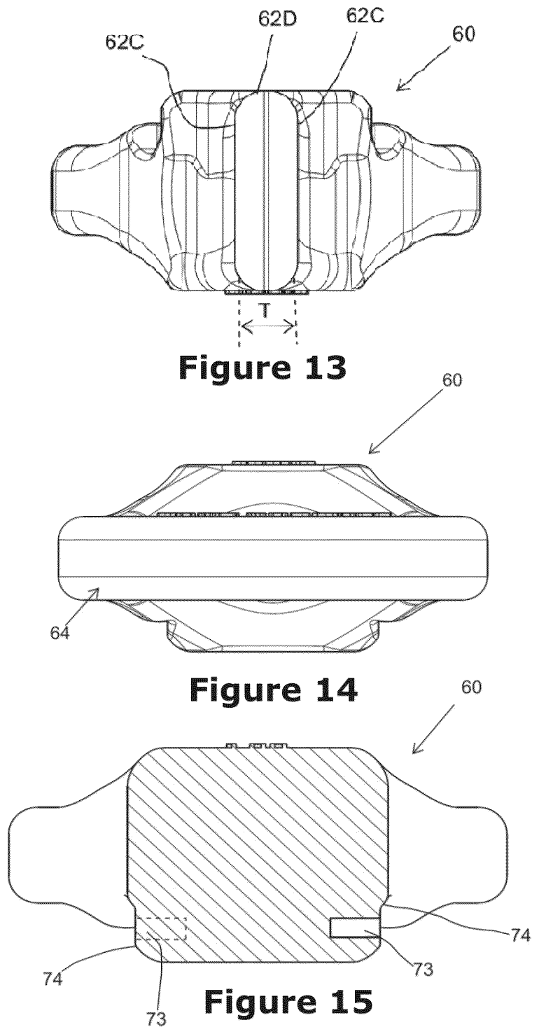

The linkage device/linkage 60, referring to FIGS. 8 to 15, is of unitary, single-piece, construction, and comprises a first or proximal link 62, having a circular aperture or opening 62A therethrough, for close receipt of the bolt 51/shank 52, and a second or distal link 64, having an aperture or opening 64A therethrough, which is integrally formed with the proximal link 62. A first or free end 62B of the link 62, which end is shown shaded in FIG. 11, has a configuration that is consistent with, and is able to be (as shown) dimensionally matched to, that of an end of an elongate loop or oval chain link-such as a link 8 of the chain 2—comprising a curved or arcuate section 62B having an external or outer portion/surface portion 62B1 which is semicircular about the axis A1, particularly a central axis through aperture 62A, and which is transversely curved, from one to the other of opposed lateral sides 62C of the end 62B/link 62, as can be seen in FIG. 9, defining an edge or edge surface/profile 62D which is convex (cross-sectionally) throughout the semicircular perimeter defined by the portion 62B or 62B1 (the convexity being apparent in the first end view of the linkage 60. The portion 62B1 thus conforms to the portion 31. More particularly, the semicircular curvatures/profiles and transverse arcuate curvatures/profiles of the portions 62B1 and 31 are complementary, conforming to complementary half-tori, whereby the former portions can lie adjacent and/or seat against the latter.

The link 64 is transverse relative to the link 62. More particularly, whereas the axis A1 is a lateral axis, a central axis A2 through opening 64A, extending from one to the other of opposed main sides/faces of the link 64/opening 64A, is perpendicular to a lateral (transverse) axis.

The breadth B of the cavity defined by the portion 31, being the dimension from one of the opposed lateral sides 31B thereof to the other, is substantially equal to, albeit slightly greater than, the thickness/breadth T of the link 62, being the dimension from one of the opposed lateral sides 62C thereof to the other, which may be substantially equal, or dimensionally matched, to the breadth/thickness of a link 8 of the chain C.

Referring to FIGS. 2, 7 and 8, the width w of the aforementioned slot, or of the part of the body 10 bounded by the parallel planes (perpendicular to axis A1) in which the laterally outer sides 32B1 lie, is substantially equal to, albeit slightly greater than, the lateral spacing L between the laterally outermost extents of the portions 66, which lateral spacing may be two (or thereabout) to three (or thereabout) times, e.g./preferably two and a half times (or thereabout), the nominal chain size or “chain wire diameter” D of the chain. The link width W may be four times (or thereabout) to five times (or thereabout), e.g./preferably four and a half times (or thereabout), the dimension D. The said lateral spacing L may, in turn or at any rate, be two fifths (or thereabout) to three quarters (or thereabout), e.g./preferably halfway (or thereabout), therebetween.

In another embodiment, the portions 66 may (in the plane perpendicular to axis A2) extend angularly, away from the distal end of link 62, further than in the example illustrated. They may, for instance, extend such that laterally outer end portions thereof conform to laterally outer end portions of a semicircle, in which case the surface portions 32, where they terminate at sides 32B1, are parallel with one another (and perpendicular to axis A1). In that case, the width w may be substantially equal to the width of a link 8 of chain 2 (being the dimension from the laterally outermost extent of one side section of the link 8 to the laterally outermost extent of the other side section of the link 8).

The link 64 defines a loop which diverges laterally outwardly in a direction from its proximal end/the link 62 to a distal/free end thereof. More particularly, the loop/link 64 is configured generally in the form of a rounded triangle, comprising side portions 64B and a base portion 64C to respective opposite lateral ends of which the side portions 64B, at distal ends thereof, connect. The loop/link 64, owing to its divergent/widening configuration, defines a relatively large amount of perimeter bounding the (likewise divergent/widening) opening 64A, particularly at/in the region of the distal/free end thereof, and especially along the base portion 64C, at any position along which the hook 3 is engageable with the loop/link 64 to be connected to the loop/link 64, whereby interconnection of the connector/hook 3 and loop/link 64 can be effected at a relatively large number of such positions and is thus facilitated.

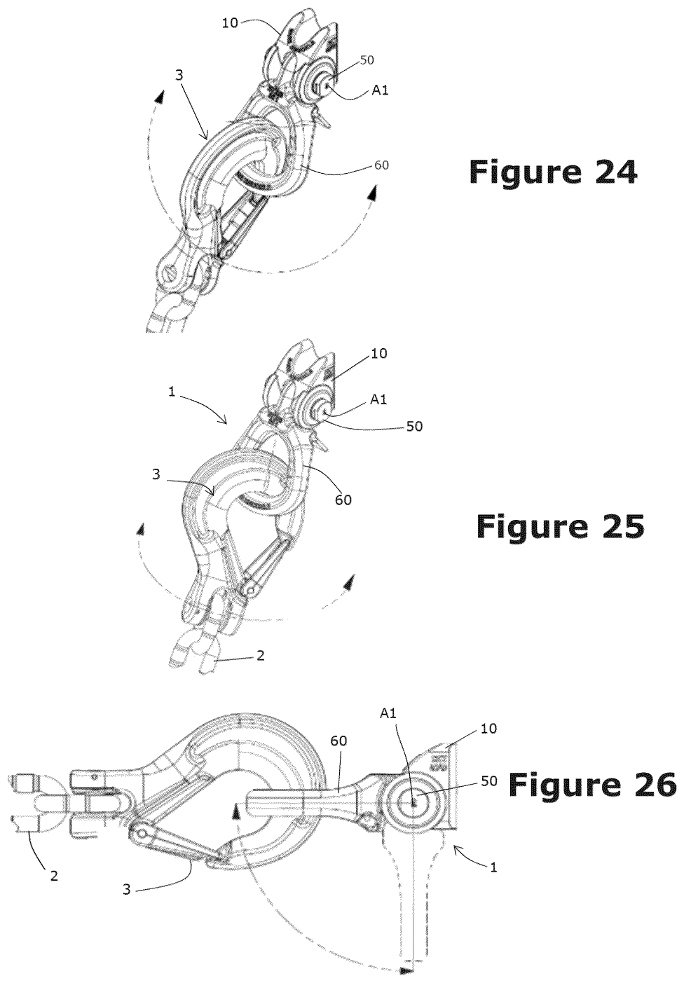

The base portion of the rounded triangle or loop/link 64 defines a bar portion 64C which is, as can best be seen in FIG. 12, tapered therealong, having opposite faces 64C1 that are convergent towards a plane P1, being the plane in which both the axis A1 and the cross section shown in FIG. 8 lie. Each lateral side portion 64B, including where it interconnects with the bar portion 64C, is likewise tapered, having opposite faces 64B1 convergent towards the plane P1. Thus defined, referring to FIG. 25, are opposing regions arranged to be abutted by respective opposing regions of the connector 3 upon the connector 3 being (sufficiently) displaced in either of opposite rotational directions (shown by the solid-head arrows in FIG. 24) about an axis which extends lengthways along the chain 2 (whereby the connector 3 fouls against the loop/link 64), the regions varying according to the position along the bar portion 64C/around the loop/link 64 at which the connector 3 engages the loop/link 64—which position is (advantageously) permitted to vary (in both a rotational and a translational sense), as indicated by the solid-head arrows in FIG. 24, owing to the (sufficient) dimensioning of the opening 64A, particularly in the region of the distal end. Advantageously, the connector 3 can be, before fouling against the linkage 60, rotationally displaced to a greater extent than if, referring to FIG. 10, the peripheral thickness dimension t of the loop/link 64 were maintained in the direction towards the opening 64A, without strength of the loop/link 64 without being (as a result of the tapering) significantly compromised.

As will be apparent from the solid-head arrows in FIGS. 24 to 26, rotational displacement of the connector 3 about three mutually orthogonal axes is possible.

The nature/extent of the displaceability of the connector 3, owing to the configuration of the linkage 60/coupling device 1, enhances reliability of the (secondary) coupling, particularly in the event of failure of the hitch/primary connection or coupling, and especially where the towing and towed vehicles jackknife.

The linkage 60 includes laterally opposed, distally divergent, shoulders 65 at the interconnection between the links 62 and 64. The shoulders 65 bolster strength/loadbearing capacity, and preclude excessive stress concentration by virtue of the profiles thereof that taper or diverge laterally outwardly in a direction from the proximal end to the distal end of the linkage 60, leading to a low strain gradient in/parallel to that direction, at the interconnection. The shoulders 65 comprise/define portions/surface portions 66, arranged to be received adjacent and/or seated against respective ones of the surface portions 32, each of which portions 66 (in a plane on which axis A1 lies and which passes through the shoulder 65) has a profile that is complementary, or is “sympathetic”, to the profile of the respective surface portion 32. More particularly, the portions 66 and 32 have complementary convex and concave (respectively) profiles, whereby the portions 66 are received adjacent and/or (slidably) seat against respective ones of portions 32. The shoulders 65 additionally comprise/define, laterally outward of the respective (“inner”) portions 66, respective (“outer”) portions/surface portions 67 each of which is arranged to be received adjacent and/or (slidably) seated against a respective one of portions 33, and (in a plane on which axis A1 lies and which passes through the/each shoulder 65) has a profile complementary to that of the portion 33, being flat or straight in a plane on which axis A1 lies and which passes through the shoulder 65 in the examples shown (but which in other embodiments may, for instance, be curved, e.g. concave or convex—with the respective portion 33 in that case being, as mentioned above, convex or concave, respectively).

It is possible that, in an alternative embodiment of the invention, laterally outer portions 67 (to be received adjacent/seat (slidably) against portions 66) may be omitted whereby the portions 32 are outer portions rather than intermediate portions.

The coupler 1 additionally comprises a standoff or spacer 70 connected to the linkage 60 to space it from, and/or orientate it relative to, the vehicle V/surface VA. The standoff/spacer 70 comprises a torsional spring element formed from resiliently deformable wire which has a bend at an intermediate position along its length, to define a tip or distal end 71 of the element 70, and which at a proximal end thereof has laterally inwardly turned ends 72, each end 72 projecting along an axis which is generally laterally extending but which is offset from/not coaxial with the axis along which the other end 72 extends, the ends 72 being received in respective (correspondingly non-coaxial) mounting holes 73 provided in the linkage member 60 adjacent a proximal end of the link 64. The element 70 defines an arm, comprising laterally opposed elongate portions formed by respective sections of the wire extending proximally from the bend. The linkage 60 is formed with smooth portions 74, which lie in respective planes perpendicular to axis A1, against which proximal ends of the said elongate portions are received to be slidably displaceable thereover when the element 70 is displaced pivotably/rotatably relative to the linkage 60.

The spacer 70 is arranged such that the tip/end 71 thereof abuts the vehicle V/surface VA to hold the link 64 spaced therefrom whereby the linkage 60, and in particular the link 64 assumes, in a “rest position” thereof, an angle θ from the vertical/plane in which the surface VA lies which angle is such that the link 64 is prominently positioned and orientated for connection of the hook 3 thereto, without any need for manual manipulation/supporting of the linkage 60, whereby connection of the hook 3 to the link 64 is facilitated, and/or which angle is such that there is protection against impacts against the vehicle V/surface VA by the link 64 and/or a hook 3 attached thereto. A force or impact against the main side/face of the link 64 that is exposed/facing away from the vehicle V/surface VA, such as a force/impact caused by inadvertent/excessive movement of the other/towed vehicle towards the vehicle V, will cause rotational displacement of the linkage 60 such that it, particularly the link 64 thereof, moves/swings towards the vehicle V/surface VA, causing flexure and rotational movement of the element 70, about each of the mounting positions defined the holes 73, whereby the element 70 exerts a torque on the linkage 60, offering a resilient bias which absorbs shock associated with the force/impact and thus reduces or eliminates impacting of the link 64—or fitting/connector/hook 3, if engaged with the link 64—against the vehicle V/surface VA, and which may return the linkage 60/link 64 to the position in which it assumes angle θ, or displace it towards that position, once the force has ceased to act or lessened. The angle θ is acute, being about 45° in the arrangement exemplified, though may vary (for example, from 15° to 45°), without departure from the invention.

The spacer/standoff 70 is removable (albeit replaceably) from the linkage 60, whereby it can be omitted, e.g. including where the body 10 is mounted to an underside/downwardly facing surface (instead of an upright/vertical surface VA) of/supported from the vehicle V, and/or in cold, greasy, dirty or high-impact conditions. It may, in that case, be that the linkage 60 can assume a rest position, in which it hangs downwardly under its own weight, such as is shown by way of phantom lines in FIG. 26.

The linkage 60/body 10 is configured such that the linkage 60 is rotationally displaceable, beyond/from the rest position shown in FIG. 26, towards the vehicle V, to an extent that it, and in particular a portion of the loop/link 64 at or near the distal end, can abut the surface VA shown in FIG. 2, whereby the limit of rotational displaceability of the linkage 60, in the direction that is anticlockwise as seen in FIG. 26, is beyond the rest position and, more particularly, is such that the said portion can enter/be in the plane in which the face 12A lies (the limit of the displaceability in the opposite direction being as shown in FIG. 26, i.e. substantially perpendicular to the rest position shown). A said force or impact against the main side/face of the link 64 that is facing away from the vehicle V/surface VA will cause rotational displacement of the linkage 60 such that the portion abuts the surface VA, whereby loading resulting from the force/impact is taken through said portion (to be borne through the surface VA and thus by the vehicle V), instead of placing the linkage 60 in bending (resulting from binding of between the linkage 60 and body 10, as a consequence of the former “bottoming out” against the latter) and in turn subjecting the body 10 to prying loads and the clevis pin/member to shearing (between the linkage 60 and body 10).

It is possible instead, without departure from the invention, for the linkage to be configured such that a portion thereof is arranged to enter/be in the said plane when a rest position is assumed by the linkage, thus abutting the surface VA.

Contouring the linkage 60 such that it conforms/is complementary to the aforementioned slot/the body 10, as described and illustrated, allows for a greater amount of material to go into defining the linkage 60, the additional material being provided at optimum regions in the linkage 60 for fortifying it/bolstering strength and duty thereof, and increasing load-bearing capacity (particularly in the transverse direction, i.e. the direction extending along apertures 22A), adding negligibly to bulk.

The body 10 and connector 50 define an attachment or attachment device, which is (suitable) for (direct) connection to a safety chain C, to couple it to a vehicle V, consistent with or being an attachment, or attachment device, as disclosed in Australian patent application and US2013204783, including in particular publication nos. AU2013204783A1 and AU2013204783B2, and U.S. patent application Ser. No. 15/533,346 and U.S. Pat. No. 10,434,830, including in particular publication nos. US20170341476A1 and U.S. Pat. No. 10,434,830B2, the entire contents of (all of) which are hereby incorporated herein by reference. The linkage 60 can thus define an adaptor/adapter and/or modifier, for use with any of the attachments or attachment devices (each comprising a body/clevis, and possibly a clevis pin) disclosed therein whereby the/a(nother) chain is connectable to that attachment/attachment device via (inter alia) the linkage 60, instead of, or rather than, being connected to the attachment/attachment device directly. Conforming to the portions 31 and 32 are the links 62 and 64 (/portions 62B1 and 66), instead of the chain leading/end link (500) and the link connected to and immediately following it (“following link” (510)) respectively.

For example, in accordance with an alternative embodiment of the invention, the linkage 60 (instead of being coupled to clevis/body 10 as shown in FIGS. 2 to 8 and 16) is coupled to a body/clevis 10′, being the body/clevis (10) shown in and described with reference to FIGS. 1 to 11 in each of the aforementioned patents, patent applications and publications-which body/clevis but for the regions 15 and holes 42 therein (mentioned below) may be identical to the clevis/body 10 shown in FIGS. 2 to 8.

The body/clevis 10′ has, in each side/side wall 20 thereof, a recessed region 15 whereby the mass thereof is reduced and the maximum thickness thereof through any given cross section is limited, for welding purposes.

The linkage device 60, advantageously, renders the attachment/attachment device operable to connect (releasably to the vehicle V) the safety chain 2 or another chain, irrespective of which the links of either are (dimensionally) matched to the attachment/attachment device, or instead a tensile restraint member of another kind, such as a towing safety cable (comprising or provided with an appropriate fitting or connector, such as (for example) a hook connector 3).

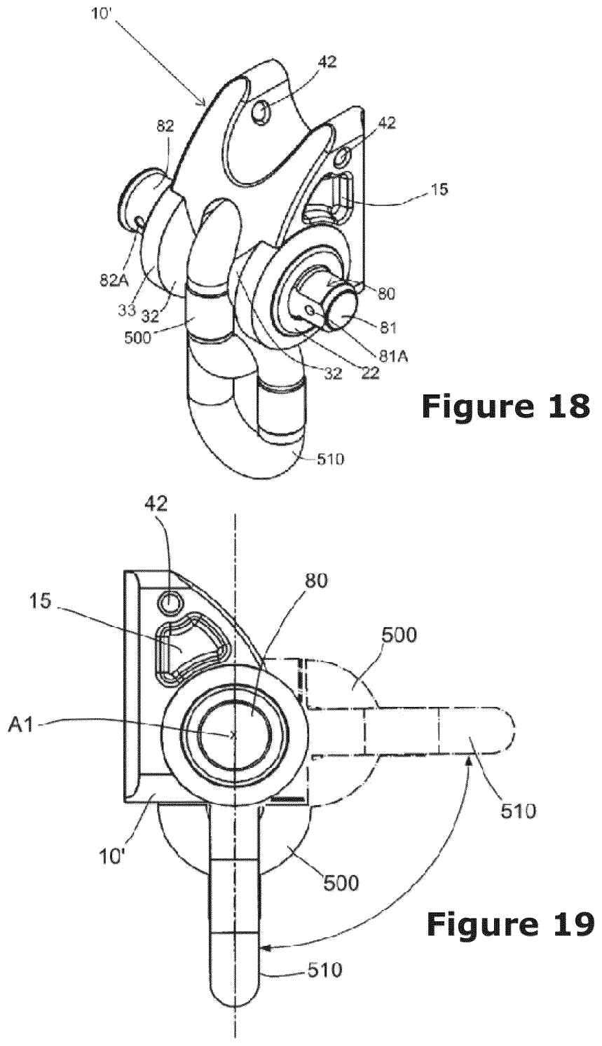

It is thus the linkage 60 that is coupled to the body/clevis 10′, instead of the leading/end link 500 and following link 510 being coupled to that body/clevis as shown in FIGS. 18 and 19. The linkage 60 may be so coupled to the body/clevis 10′ via a pivot connector 50 as described and illustrated herein.

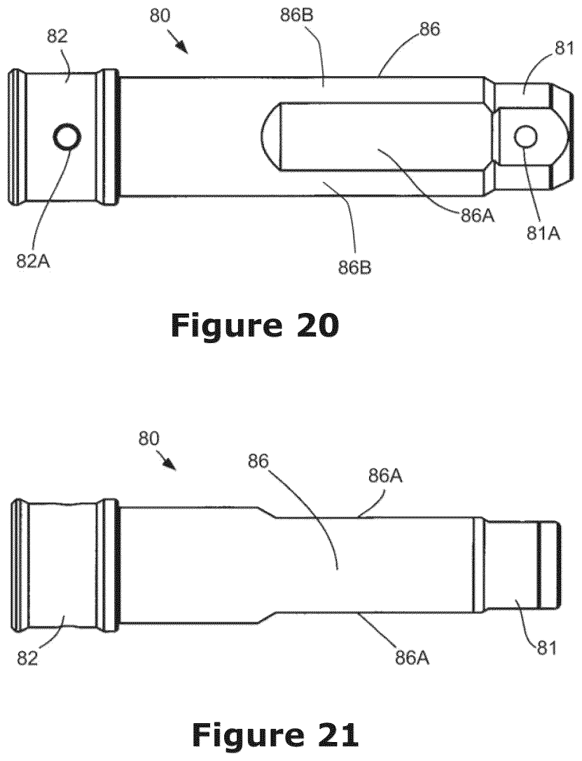

The linkage 60 may, in a variant of the alternative embodiment, be coupled to the body/clevis 10′ via a connecting member, comprising a pivot connector 80, which comprises the clevis pin (60) as described and illustrated in any or each of the aforementioned patents, patent applications and publications, in essentially the same way that the leading/end link 500 and following link 510 are so coupled as shown in FIGS. 18 and 19. The pivot connector/clevis pin 80 includes, referring additionally to FIGS. 20 and 21, a leading end 81 and has a head 82 at a trailing end thereof. A wire lanyard (not shown) is connected to the leading end 81, through a hole 81A therethrough, passed through holes 42 through the body 10′, and attached to the head 82 via a suitable component, e.g. a linchpin, through a hole 82A therethrough.

A shank or body 86 of the pin 80 has opposed flats or flattened portions 86A extending partially along its length. When link 500 is connected to the body/clevis 10′ using the pin 80, each of curved portions 86B of the shank/body 86, extending between respective adjacent sides of the portions 86A, mates with a respective one of opposed curved portions 62A1 and 62A2 of the link 62. While the flat portions 86A may be redundant where the pin 80 is used to connect the linkage 60 to the body, the pin 80 can (assuming it is sufficiently strong) define a said connecting member notwithstanding, whereby each of the pin and connecting members may be defined by a (respective) given said pin—as may be desirable for the purposes of restricting numbers of differing parts.

The linkage 60 may rotate relative to the body/clevis 10′ about the axis A1 of the pin 80, in the same way as do the leading/end link 500 and following link 510 as shown in FIGS. 18 and 19.

The head 82 may include a groove (not shown) to accommodate a circlip or other component, which bears against the boss 22 adjacent to which that head is received, to restrain the pin 80 against transverse movement relative to the body/clevis 10′. This improves load transfer into the pin 80, thus further reducing any tendency for the sides 20 to be forced apart. As will be appreciated, any number of other means of securing the pin 80 may be employed to achieve the same or a similar effect, including but not limited to a pin, bolt, or tapered shank bolt.

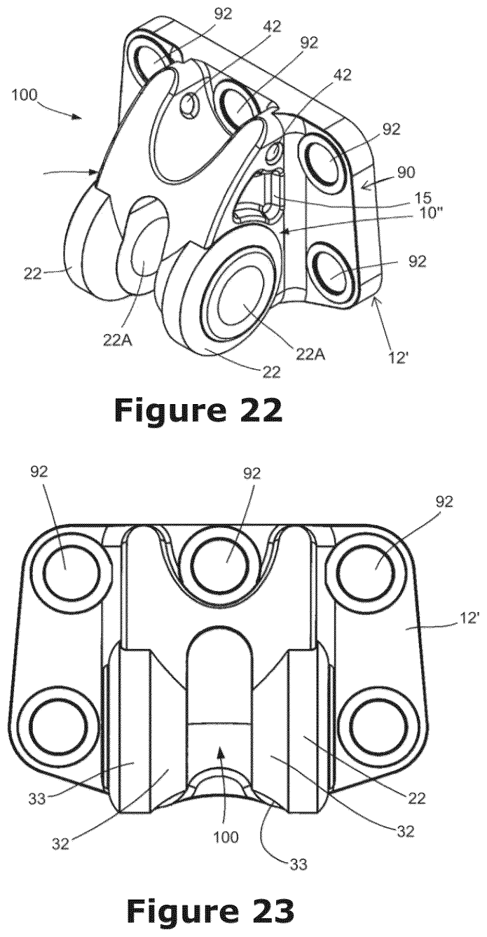

In accordance with another alternative embodiment of the invention, referring to FIGS. 22 and 23, the linkage 60 (instead of being coupled to body/clevis 10 or 10′ as described and illustrated herein) is coupled to a body/clevis 10″ of a component 100, being the component (1200) shown in, and described with reference to, FIGS. 12 to 14 in each of the aforementioned patents, patent applications and publications, this component comprising in addition to the body/clevis 10″ (having substantially the same structure as the body/clevis 10′ as described and illustrated herein), a base 12′ to which the body/clevis 10″ is attached or affixed-which base may, as will be clear from FIGS. 22 and 23, take the form of a mounting plate or flange, and is suitable for bolt-on applications. The base 12′ has holes 92 for bolts or other fasteners, whereby the body/clevis 10″ of the component 100 can be affixed (via such bolts/fasteners), via the base 12′, to the support face/surface VA. The base 12′ may be integral with the body 10″/portion which comprises or defines body 10″, whereby the component 100 may be unitary or of single-piece construction. Alternatively, the body 10″/portion may be affixed/attached to base 12′ by any suitable means, e.g. welding.

The linkage 60 may, in a variant of the further alternative embodiment, be coupled to the body/clevis 10″ via the pivot connector 80, comprising the clevis pin (60) as described and illustrated in each of the aforementioned patents, patent applications and publications, in essentially the same way that the leading 500 and following 510 links are coupled to the body/clevis 10″ as shown in FIGS. 18 and 19. As mentioned above, a wire lanyard (not shown) is connected to the leading end 81, through hole 81A, passed through holes 42, and attached to the head 82 via a suitable component, e.g. a linchpin, through hole 82A.

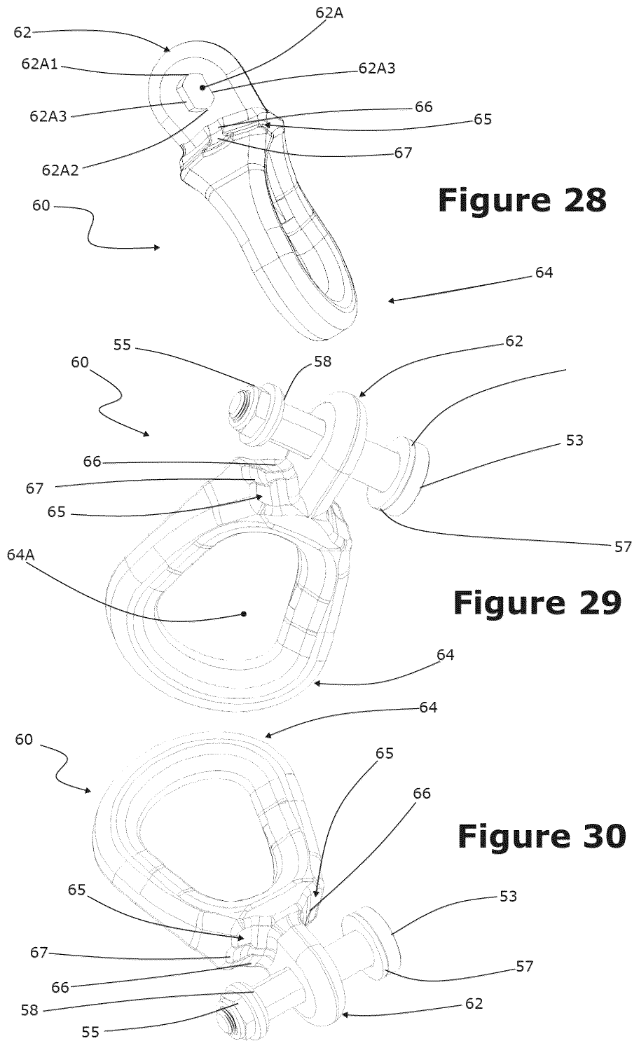

Referring to FIG. 28, the linkage 60/link 62 may, without departure from the invention, be provided with opposed flattened portions or flats 62A3 arranged to mate with respective ones of pivot connector flats 52A or 86A (in which case such flats are not redundant in the way they may be as mentioned above), whereby the linkage 60/link 62 is rotationally locked to the pivot connector/connecting member 50 or 80, and the latter is thus rotatable together with the former about the axis A1. Shown in each of FIGS. 29 and 30 is an assembly, to form part of coupler 1 in accordance with a preferred embodiment of the invention, the assembly comprising the linkage 60 as illustrated at FIG. 28 and the connector 50, and further comprising a friction washer 57 arranged over the shank to be disposed between the head 53 and the body 10/10′ (not shown) and a friction washer 58 arranged over the shank to be disposed between the nut 55 and body 10/10′, in light of the rotation of the connector 50 (including the head 53 and nut 55) relative to the body when the linkage 60 rotates/pivots. The friction washers 57,58 are made of a fibre material. In alternative embodiments, the friction washers 57,58 may be made from hard rubber.

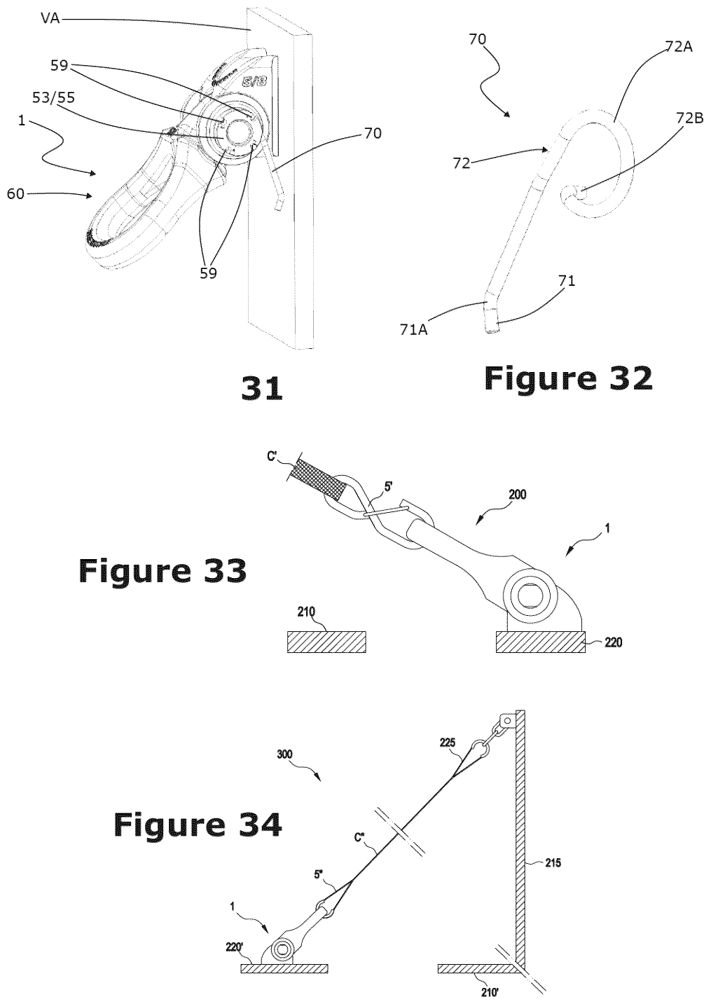

Referring to FIGS. 31 and 32, the coupler 1 in accordance with such an embodiment, may comprise a standoff/spacer 70 which, rather than being connected to the linkage 60, is connected to the pivot connector/connecting member 50. The standoff/spacer 70 (like that which connects to linkage 60) comprises a torsional spring element formed from resiliently deformable wire, and is configured such that a tip or distal end 71 thereof abuts the surface VA of the structural component/vehicle V, the tip/end 71 being defined by an end portion of the wire, which portion may be formed with an elbow or bend 71A defining a portion of the tip/end 71 arranged to contact/abut the surface VA. The other end portion of the wire is bent to form, at the proximal end 72 of the standoff/spacer 70, a loop portion 72A, which is dimensioned to underlie the head 53 or nut 55 (and to overlie washer 57 or 58 respectively, if provided), and a laterally out-turned end 72B arranged to be (when the portion 72A does so) received in an opening 59, such as a radially outwardly opening notch, in a peripheral part of head 53 or nut 55 respectively, which may be any one of plural such openings/notches 59 arranged at circumferentially spaced positions around the head 53 or nut 55.

The upstand/spacer 70 is arranged such that the tip/end 71 thereof abuts the surface VA to hold the link 64 spaced therefrom whereby the linkage 60, and in particular the link 64 assumes, in a “rest position” thereof, angle θ from the vertical/plane in which the surface VA lies, such that (as discussed above) the link 64 is prominently positioned and orientated for connection of the fitting or connector 3 thereto, without any need for manual manipulation/supporting of the linkage 60, whereby connection of the fitting/connector 3 to the link 64 is facilitated, and/or there is protection against impacts against the vehicle V/surface VA by the link 64 and/or a fitting/connector 3 attached thereto. More particularly, the link 64 projects away from the surface VA so that it is easier for a towing operator to connect a fitting or connector 3. A force or impact against the main side/face of the link 64 that is exposed/facing away from the vehicle V/surface VA, such as a force/impact caused by inadvertent/excessive movement of the other/towed vehicle towards the vehicle V, will cause rotational displacement of the linkage 60 such that it, particularly the link 64 thereof, moves/swings towards the vehicle V/surface VA, causing the end 72B to be rotationally displaced with the head 53/nut 55, as the distal end 71 abuts surface VA, tending to wind the loop portion 72A further (in the direction in which it is bent/wound), causing flexure of the element 70, about the end 72B, whereby the element 70 exerts a torque on the linkage 60, offering a resilient bias which absorbs shock associated with the force/impact and thus reduces or eliminates impacting of the link 64—or fitting/connector 3, if engaged with the link 64—against the vehicle V/surface VA, and which may return the linkage 62/link 64 to the position in which it assumes angle θ, or displace it towards that position, once the force has ceased to act or lessened.

The upstand/spacer 70 may be, in other embodiments of the invention, omitted. In these embodiments, the link (64) may be retained in the “rest position” only by the friction between friction washers 57,58 and the body 10 induced by tightening the nut 55. The nut 55 may need to be tightened periodically as the friction washers 57,58 compress and wear over time. The friction fitting allows for the link to project away from the surface VA without the operator needing to manually retain it in such position.

The invention also has application to load binding (including restraints for securing loads supported on vehicle trays and beds). FIG. 33 shows details of an assembly 200 which comprises a support structure 210, e.g. comprising a bed or tray of a vehicle, on which there is supported a load (not shown) to be transported by the vehicle, a belt or strap 2′ engaging the load to hold/tie it down to/against the support structure 210, a coupler or coupling device 1, a structural component 220 to which the coupler/device 1 is secured (such as in a manner as described above in connection with any of the previous embodiments), which component may be defined by or adjacent and/or secured to or adjacent the vehicle (and may comprise or be defined by, for example, a frame or beam member and/or the support structure 210 itself), and a fitting or connector 3′, e.g. comprising a hook or karabiner, connecting (preferably releasably) an end of the belt/strap 2′ to the coupler/device 1 (and thus to the component 220/vehicle via the coupler/device 1. The other end of the belt/strap 2′ (not shown) is also connected to another structural component (which component (like component 220) may be defined by or adjacent and/or secured to or adjacent the vehicle, and may comprise or be defined by, for example, a frame or beam member and/or the support structure 210 itself), and may be so connected via a fitting/connector 3′ and coupling device 1 (as shown) or via a different interconnecting arrangement.

The invention additionally has application to guying/restraining of structures. FIG. 34 shows details of an assembly 300 which comprises a support or support structure 210′, e.g. comprising a slab or foundation and/or a support/mounting member or plate secured thereto, a structure 215 supported by/on/over the support/structure 210′, a wire or cable 2″ for guying the structure 215, a coupler or coupling device 1, a structural component 220 to which the coupler/device 1 is secured (such as in a manner as described above in connection with any of the previous embodiments), which component may comprise (for example) an anchor member or plate secured to a/the slab or foundation, a fitting or connector 3″ connecting (releasably or permanently) one end of the wire/cable 2″ to the coupler/device 1 (and thus to the component 220 via the coupler/device 1), and another structural component 225 via which the other end of the wire/cable 2″ is connected to the structure 215.

Whereas in the embodiments described and illustrated with reference to FIGS. 1 to 32, the tensile restraint member 2 (e.g. comprising a towing safety chain or cable) is slack (not taut or tensioned), only assuming a taut or tensioned condition where the primary connection or coupling fails, the tensile restraint member in each of the embodiments described with reference to FIGS. 33 and 34 (comprising member 2′/2″) is constantly taut/tensioned. Advantageously, the linkage 60, owing to its being pivotable/rotatable about axis A1, can pivot/rotate about that axis to extend in the direction of the tensile restraint member 2′/2″/loading therethrough.

The invention also has other applications, including to any (one or more) of (inter alia) lifting, handling and harnessing (e.g. belaying) of loads, in which case at least one coupler/device 1 is defined by or adjacent, and/or secured to or adjacent, the load and/or an apparatus for supporting the load, and the tensile restraint member(s) connected between the apparatus and load, whereby the load is supported/supportable from the apparatus via the tensile restraint member(s) (in a tensioned condition) and the coupler/device(s) 1.

Provided in a preferred embodiment of the invention is an assembly comprising the vehicle V, said other vehicle arranged to tow or be towed by it, at least one chain 2 connected at one end thereof, via a respective connector 3, to a respective said coupler (such as coupler 1) the body of which is supported from the vehicle V, and secured at the other end thereof to the other vehicle.

In a preferred version of that embodiment, the assembly includes plural couplers the bodies of which are supported from the vehicle V (at respective positions), plural chains 2 each secured at the said other end thereof to the other vehicle, and plural connectors 3 each connecting the said one end of a respective chain 2 to the vehicle V.

Preferably, the plural couplers, chains C, connectors 3 consist of a pair of couplers, a pair of chains 2 and a pair of connectors 3.

Preferably, the/each other end is secured to the other vehicle via a (respective) attachment or attachment device (of a kind) as described/illustrated, the body of the/each attachment or attachment device being supported from the towed vehicle (at a respective position), a (respective) free/axially outer end of the end link of the/each chain 2 at said other end thereof (“trailing end link”) is rotatably/pivotally connected to the body/clevis of the (respective) attachment or attachment device, via a (respective) said pin member, whereby the chain 2 is secured to the other vehicle, such that there is maintained a close fit between the/each clevis and (respective) chain C, particularly between the clevis(es) and the (respective) trailing end link and link connected thereto (“trailing end following link”), as the trailing end link and trailing end following link rotate relative to the clevis about a transverse axis.

Also provided in a preferred embodiment of the invention is a kit comprising one or more towing safety cables or chains 2 and one or more linkage or coupling devices, to be associated with a respective said safety cable or chain C, for interconnecting the end(s) of said safety cable or chain(s) 2 to a said vehicle V via said distal end(s).

In a preferred version of that embodiment, the kit includes plural said safety cables or chains C and plural said linkage or coupling devices.

Preferably, the plural safety cables or chains C and plural linkage or coupling devices consist of a pair of safety cables or chains 2 and a pair of linkage or coupling devices.

Preferably, the kit includes, for securing the other end of the/each chain 2 to the other vehicle, one or more attachments or attachment devices (of a kind) as described/illustrated, the body of the/each attachment or attachment device supportable from the towed vehicle (at a respective position), a (respective) free/axially outer end of the end link of the/each chain 2 at said other end thereof (“trailing end link”) being rotatably/pivotally connected or connectable to the body/clevis of the (respective) attachment or attachment device, via a (respective) said pin member, whereby the chain 2 is secured to the other vehicle when the (respective) body is supported from the vehicle (at said position), such that there is maintained a close fit between the/each clevis and (respective) chain 2, particularly between the clevis(es) and the (respective) trailing end link and link connected thereto (“trailing end following link”), as the trailing end link and trailing end following link rotate relative to the clevis about a transverse axis.

The kit may, advantageously, comprise the componentry to be connected to/between the vehicles to define the secondary means of interconnecting them (such as in an assembly as described above), and by being (as is preferred) compliant with applicable regulations, provide for regulatory compliance of the secondary means of interconnection once established.

Coupling devices according to preferred embodiments of the present invention can, advantageously, replace or be provided instead of, hangers as discussed above.

Each of the features of the embodiments disclosed herein may be combined with any of the other features thereof, in further embodiments of the invention.

It will be appreciated that various modifications, additions and alterations may be made to the invention by one skilled in the art without departing from the spirit and scope of the invention as defined in the appended claims.

In certain embodiments of the invention, including variants of the embodiments herein described and illustrated, the linkage and body/clevis do not have respective complementary portions.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A coupling device for interconnecting a tensile restraint member and a structural component, the coupling device comprising:
a body adapted to be supported from the structural component; and
a linkage having:
a proximal end adapted to be rotatably coupled to the body such that the linkage or proximal end is rotationally displaceable relative to the body about a transverse axis; and
a distal end configured such that said tensile restraint member is connectable thereto.

2. A coupling device according to claim 1, including a connecting member via which said proximal end is engageable with the body to be rotatably coupled thereto.

3. A coupling device according to claim 2, wherein the body defines a clevis having laterally spaced arms arranged to receive said proximal end therebetween, and said member defines a clevis pin configured to extend between the arms to couple the proximal end rotatably to the body.

4. A coupling device according to claim 1, wherein the linkage and the body have respective complementary portions such that a close fit is maintained therebetween throughout a range of rotational displacement of the linkage about the axis.

5. A linkage device for interconnecting a tensile restraint member and a structural component, the linkage device being co-operable with an attachment device which comprises a body defining a clevis having lateral side sections and an opening therebetween, the side sections being configured to receive a connecting member whereby said member extends across the opening and a central axis of a clevis pin thus defined by said connecting member is coaxial with a transverse axis, the linkage device being configured to define a linkage having:
a proximal end receivable in the opening to be engageable with the connecting member, when said member is received by the side sections to extend across said opening, so as to be rotatably coupled to the body such that the linkage is rotationally displaceable relative to the body about said transverse axis; and
a distal end configured such that said tensile restraint member is connectable thereto.

6. A linkage device according to claim 5, being co-operable with a said attachment device:
which attachment device is suitable for use with a chain having a link at an end thereof (“end link”) and, connected to and following the end link in a direction therefrom along the chain, another link (“following link”);
in which attachment device the opening is configured to receive a free end of the end link, or an end of the end link opposite to that to which the following link is connected, whereby a pin member, when received by the side sections so as to extend across the opening such that a central axis of a clevis pin thus defined by the pin member is coaxial with the transverse axis, passes through said end of the end link, thus coupling the end link to the body whereby the end and following links are rotatable relative to the clevis about the transverse axis; and
in which attachment device the body is configured such that:
a portion of the clevis between the side sections has a configuration complementary to a configuration of the said end of the end link; and/or
portions of the side sections have configurations which are complementary to a configuration of an end of the following link via which that link is connected to said end link,
whereby there is maintained a close fit between the clevis and said chain, and/or said complementary portions, as the end link and following link rotate relative to the clevis about said transverse axis,
wherein:
a portion of the proximal end has a configuration which conforms to that of the said/free end of the end link and/or which is complementary to that of a said portion of the clevis, whereby the portions of the proximal end and clevis are complementary; and/or
portions of the linkage have configurations which conform to a configuration or configurations of a said end of the following link and/or which are complementary to those of said portions of the side sections, whereby the portions of the linkage and side sections are complementary,
such that a close fit is maintained between the complementary portions, and/or between the linkage and the body, throughout a range of rotational displacement of the linkage about the axis.

7. A coupling device comprising a linkage device according to claim 6 and said attachment device, the coupling device including said connecting member, wherein said proximal end is received in the opening and the connecting member is received by the side sections so as to extend across the opening such that the proximal end engages the connecting member to be rotatably coupled to the body via the connecting member, whereby the linkage is rotationally displaceable relative to the body about said transverse axis.

8. A device according to claim 4, wherein said portions of the linkage comprise laterally opposed portions profiled to conform to respective laterally opposed ones of said portions of the body or side sections, whereby the complementary portions comprise the laterally opposed portions of the linkage and body or side sections.

9. A device according to claim 8, wherein said laterally opposed portions of the linkage are profiled to conform circumferentially and transversely to the laterally opposed portions of the body or side sections.

10. A device according to claim 9, wherein the laterally opposed portions of the linkage have convex profiles transversely, the laterally opposed portions of the body or side sections having complementarily concave profiles.

11. A device according to claim 8, wherein the laterally opposed portions of the linkage are defined by a region or interconnection between the proximal and distal ends or respective links defining those ends.

12. A device according to claim 8, wherein the proximal end includes a portion that is convex about said axis, such that a portion of the body which is concave about said axis conforms to the convex portion, whereby the complementary portions comprise the concave and convex portions.

13. A device according to claim 8, wherein the proximal end comprises an edge which has a profile that is transversely convex, or which is radially outwardly arcuate, therealong, such that a portion of the body which has a transversely concave profile, or which defines a channel that is radially outwardly arcuate therealong, conforms to the edge, whereby the complementary portions comprise the edge and the portion having said transversely concave profile or defining the radially outwardly arcuate channel.

14. A device according to claim 8, wherein the proximal end includes an aperture or bore arranged to receive said member, or a pin or connecting member, therethrough such that the proximal end is rotatably coupled to the body.

15. A device according to claim 5, wherein the linkage is of unitary or single-piece construction.

16. A device according to claim 5, wherein the linkage includes a ring or loop portion defining the distal end, over or around which portion a connector or fitting is receivable to connect the tensile restraint member thereto.

17. A device according to claim 5, wherein the linkage defines opposing regions each of which has opposite faces convergent towards a plane passing through the opposing regions, such that each region is of reducing thickness in a direction towards the other, whereby respective ones of the faces of said regions to opposite sides of said plane are abuttable by respective opposing regions of a connector or fitting of/attached to the tensile restraint member, defined around the connector or fitting, upon the connector or fitting being displaced to a sufficient extent in either rotational direction about an axis which extends between distal and proximal ends of the connector or fitting and/or lengthways along the tensile restraint member and through the connector or fitting.

18. A device according to claim 17, wherein said opposing regions or regions of reducing thickness comprise regions defined by and along opposed lateral side portions of the linkage each of which extends in a direction from said proximal end and towards said distal end.

19. An assembly comprising at least one device according to claim 1 and at least one said structural component, and including at least one said linkage, wherein at least one said body is supported from the structural component(s), and the proximal end of the or each linkage is rotatably coupled to a respective said body whereby the linkage is rotationally displaceable relative to that body about a said transverse axis.

20. An assembly according to claim 19, wherein said at least one other component, or structure which defines or to which is/are secured said other component(s), is arranged to draw or be drawn by the at least one structural component, or structure which defines or to which is/are secured said structural component(s).
